(19) United States
(12) Patent Application Publication
(10) Pub. No.: US 2026/0285339 A1
(43) Pub. Date: Sep. 24, 2026

(54) SYSTEM

(71) Applicant: SoftBank Group Corp., Tokyo (JP)

(72) Inventor: Fumina YOKOI, Tokyo (JP)

(73) Assignee: SoftBank Group Corp., Tokyo (JP)

(21) Appl. No.: 19/564,236

(22) Filed: Mar. 12, 2026

(30) Foreign Application Priority Data
Mar. 19, 2025 (JP) 2025-044963

(51) Int. Cl. B60W 50/08; B60W 50/00; B60W 60/00; G05B 13/02

(52) U.S. Cl. CPC B60W 50/08; B60W 60/001; G05B 13/027; B60W 2050/0022; B60W 2420/40; B60W 2420/54; B60W 2540/22; B60W 2554/40; B60W 2556/10; B60W 2556/35; B60W 2556/45

(57) ABSTRACT

A system includes a processor that is configured to: control a vehicle to provide an autonomous driving function, cooperate with a vehicle sharing service to manage reservation information and usage status, obtain location information and generate a prompt that instructs a generative AI model to generate detailed information on tourist spots in order to provide a tourist guide based on the location information, and recognize a user emotion and adjust content of the tourist guide in accordance with the user emotion.

### CROSS-REFERENCE TO RELATED APPLICATION

This application is based on and claims priority under 35 USC 119 from Japanese Patent Application No. 2025-044963 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional in-vehicle guidance systems, including navigation systems and basic tourist information services, generally provide static information that is not sufficiently tailored to the real-time context of a shared vehicle trip or to the individual user's state. In particular, such systems typically (i) do not tightly integrate autonomous driving control with a vehicle sharing service, (ii) do not utilize location information in combination with a generative AI model to dynamically generate rich, up-to-date tourist information, and (iii) do not adapt the content of a tourist guide based on user emotion or detailed driving situations such as traffic jams, changes in speed, or road conditions. As a result, the user may receive tourist information that is generic, outdated, or inappropriate for the current emotional state or driving context, which reduces user satisfaction and fails to fully utilize the available travel time in an autonomous or shared vehicle.

Accordingly, there is a need for a system that can: control a vehicle to provide an autonomous driving function, coordinate with a vehicle sharing service to manage reservation information and usage status, utilize real-time location information to generate prompts for a generative AI model to produce detailed tourist information, and recognize user emotion and driving conditions so as to adjust the content of the tourist guide dynamically. The objective of the present invention is to provide such a system and thereby enhance the quality, personalization, and contextual relevance of tourist guidance provided to a user during vehicle travel.

### SUMMARY

To solve the above problems, the present invention provides a system comprising a processor, wherein the processor is configured to control a vehicle to provide an autonomous driving function and to cooperate with a vehicle sharing service to manage reservation information and usage status associated with the vehicle. The processor is further configured to obtain location information of the vehicle, and, based on the location information, to generate a prompt that instructs a generative AI model to generate detailed information on tourist spots so that a tourist guide can be provided in accordance with the current position of the vehicle. The processor is also configured to recognize a user emotion and to adjust content of the tourist guide in accordance with the recognized user emotion, thereby personalizing the guidance to the user's current state.

In one aspect, the processor is configured to detect a driving situation of the vehicle by using at least one sensor, to generate a prompt that instructs a change of content of the tourist guide dynamically in accordance with the detected driving situation, and to change the content of the tourist guide by using the prompt. For example, when a traffic jam or low-speed condition is detected, the processor can cause more detailed or extended tourist information to be presented to the user.

In another aspect, the processor is configured to generate a prompt that instructs a generative AI model to generate detailed information on a tourist spot including at least one of a history, a cultural background, a recommended time zone, a recommended season, and a caution relating to the tourist spot, and to provide the prompt as an input to the generative AI model. By doing so, the system can automatically obtain rich, context-sensitive tourist information and present it to the user in a manner adapted to both real-time driving conditions and the user's emotional state, thereby achieving the object of the invention.

The term “system” refers to an assembly of one or more hardware components, software components, or a combination thereof, including at least a processor, which cooperatively perform the functions described in the present specification and claims.

The term “processor” refers to any circuit, device, or combination of hardware and software, such as a central processing unit (CPU), microcontroller, digital signal processor (DSP), application specific integrated circuit (ASIC), field programmable gate array (FPGA), or similar component, that is capable of executing instructions to perform the operations described in the present specification and claims.

The term “vehicle” refers to any means of transportation capable of carrying at least one passenger, including but not limited to an automobile, bus, taxi, shuttle, or other ground vehicle, and is not limited to a particular drive source or body type.

The term “autonomous driving function” refers to a function by which the vehicle is controlled, at least in part, without continuous operation by a human driver, including automatic control of acceleration, braking, steering, or route following based on sensor inputs and control algorithms.

The term “vehicle sharing service” refers to a service or platform that allows multiple users to reserve and use one or more vehicles on a time-shared or usage-based basis, and that manages reservation information, vehicle allocation, and usage records for such vehicles.

The term “reservation information” refers to data associated with a booking or scheduled use of a vehicle, including at least one of a user identifier, vehicle identifier, pickup time, return time, pickup location, return location, and usage plan.

The term “usage status” refers to information indicating a current or past state of use of a vehicle in the vehicle sharing service, including at least one of whether the vehicle is reserved, in use, available, under maintenance, or returned, and optionally including duration of use, distance traveled, and usage history.

The term “location information” refers to data indicating a geographical position of the vehicle or user, including at least one of latitude, longitude, altitude, timestamp, and accuracy information, and optionally including additional derived information such as a region name or point of interest.

The term “tourist guide” refers to information provided to a user for sightseeing or travel support, including recommendations or explanations regarding tourist spots, routes, facilities, events, restaurants, shops, or other points of interest.

The term “generative AI model” refers to a machine learning model, such as a large language model or other generative model, that is capable of generating text, audio, images, or other content in response to an input, such as a prompt, by statistically modeling patterns in training data.

The term “prompt” refers to data, including text or structured parameters, that is provided as an input to a generative AI model and that instructs or conditions the generative AI model to generate output content corresponding to a desired topic, style, or level of detail.

The term “tourist spot” refers to any place or facility that may be of interest to a traveler or visitor, including at least one of a historical site, cultural facility, natural scenery, shopping area, entertainment facility, restaurant, or other point of interest.

The term “user emotion” refers to an estimated or detected emotional state of the user, including but not limited to happiness, interest, boredom, stress, fatigue, or discomfort, which is recognized by the system based on at least one of sensor data, user behavior, or user input.

The term “driving situation” refers to a condition related to the operation of the vehicle, including at least one of vehicle speed, acceleration, deceleration, traffic congestion, road type, road surface condition, weather condition, and presence of stops or delays, as detected by one or more sensors or systems.

The term “sensor” refers to any device or module that can measure or detect a physical quantity or environmental condition and output a corresponding signal, including but not limited to GPS sensors, speed sensors, cameras, radars, lidars, accelerometers, gyroscopes, microphones, and vehicle internal sensors.

The term “history” refers to information relating to past events or origins associated with a tourist spot, including at least one of a founding date, founder, historical developments, notable incidents, and changes over time.

The term “cultural background” refers to information related to cultural, religious, artistic, or social aspects associated with a tourist spot, including at least one of traditions, customs, religious affiliations, architectural styles, festivals, and local practices.

The term “recommended time zone” refers to a recommended time period within a day during which visiting a tourist spot is favorable, including at least one of morning, afternoon, evening, or night, and optionally including more specific time ranges.

The term “recommended season” refers to a recommended period within a year during which visiting a tourist spot is favorable, including at least one of spring, summer, autumn, and winter, and optionally including more specific months or dates.

The term “caution” refers to advisory information or warnings provided to the user in relation to a tourist spot, including at least one of safety precautions, accessibility issues, crowding conditions, dress codes, prohibited behaviors, opening hours, and environmental risks.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

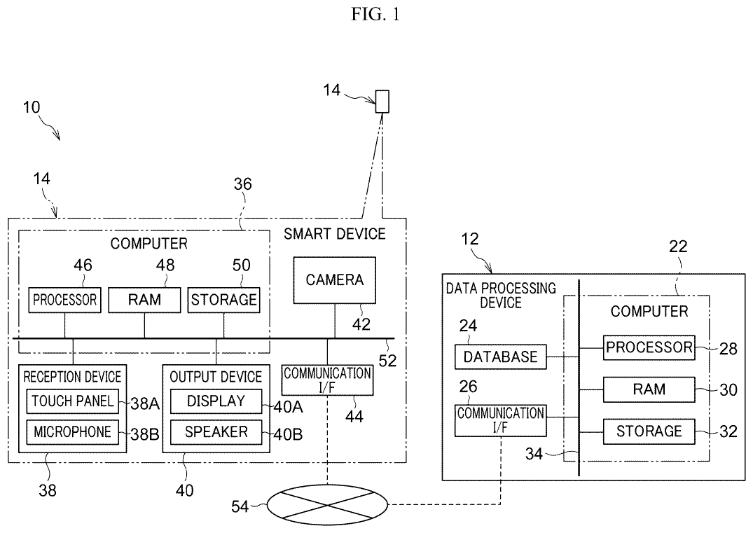

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

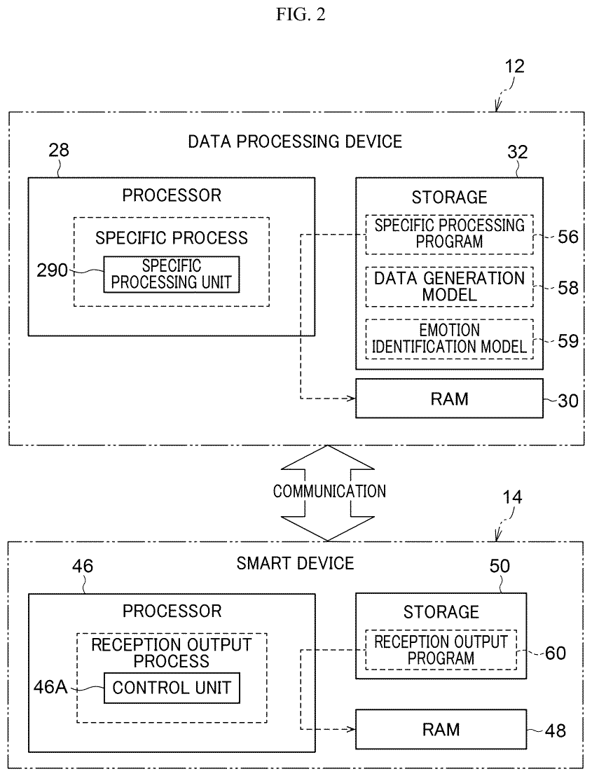

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented sightseeing guidance systems that utilize location information typically perform a simple lookup of points of interest near a current position and return static text fragments prepared in advance. Such systems suffer from several technical limitations. First, the server-side processing often couples raw sensor data, database lookup results, and user interface logic in an ad hoc manner, resulting in rigid response generation pipelines that cannot flexibly adapt to changes in position, context, or user preferences in real time. Second, existing systems generally do not manage a machine-readable, structured representation of nearby sightseeing objects that is specifically optimized to be consumed by a generative AI model, and therefore cannot fully exploit generative models to synthesize coherent, context-aware natural language guidance. Third, many systems handle updates of position information in a coarse-grained or batch-oriented way, which leads to redundant data transmissions, inconsistent presentation states between server and terminal, and inefficient utilization of communication and computation resources.

In addition, conventional architectures typically treat prompt construction for a generative AI model as a simple string concatenation task, without explicitly encoding priority information based on distance, display style instructions, or user attribute information into the prompt itself. As a result, the generative AI model cannot reliably generate output that is aligned with the current physical context of the mobile body, the user's dynamic preferences, and the constraints of the terminal display. This lack of structured, context-enriched prompt construction degrades the technical performance of the overall system, for example by increasing the need for repeated requests, increasing server latency, and forcing the terminal to perform additional client-side filtering and formatting.

Moreover, known systems generally do not maintain a systematic generation history and transmission history of guidance information that is tied to the sequence of position updates. Without such historical control information, the server cannot efficiently determine when to regenerate guidance, how to avoid unnecessary recomputation by the generative AI model, or how to manage synchronization with the user terminal in a way that minimizes bandwidth and processing load. This leads to suboptimal use of computing resources on the server and unstable user experiences on the terminal.

Accordingly, there is a need for an improved computer-implemented sightseeing guidance system in which a server acquires position information of a mobile body, derives structured sightseeing object information from a storage device, programmatically constructs prompt sentences embedding structured context for a generative AI model, and manages generation and transmission histories so that natural language guidance can be generated and updated efficiently and consistently in response to changes in position and user-related parameters. The technical problem to be solved is to improve the way in which the server-side computer system represents, processes, and updates location-based sightseeing information and prompt sentences, thereby enhancing computational efficiency, adaptability, and synchronization with a user terminal in a generative AI-based guidance environment.

The specific processing by the specific processing unit 290 of the data processing device 12 in Example 1 is realized by the following means.

The present invention provides a server comprising a processor configured to acquire position information of a mobile body by using a positioning device; to specify a surrounding area based on the position information and to extract sightseeing-related information, as sightseeing object information, from an information storage device in which sightseeing-related information is recorded in association with areas; to generate structured information including at least a name, a type, and an outline of each sightseeing object on the basis of the sightseeing object information and the position information, and to generate a prompt sentence including the structured information and user attribute information; to input the prompt sentence to a generative AI model, to instruct the generative AI model to generate a sightseeing guidance natural language description, and to obtain the sightseeing guidance natural language description from the generative AI model; to format guidance information data including the sightseeing guidance natural language description and the sightseeing object information into a predetermined data format and to transmit the guidance information data to a user terminal; and to record a generation history and a transmission history of the guidance information data and to sequentially update the prompt sentence and the sightseeing guidance natural language description in response to updating of the position information. This enables the server-side computer system to maintain a structured, context-rich representation of nearby sightseeing objects, to construct technically optimized prompt sentences for the generative AI model, and to update and deliver natural language guidance in a resource-efficient, synchronized, and context-aware manner as the position of the mobile body changes.

The term “mobile body” refers to a movable apparatus, such as a vehicle or other transport device, whose position changes over time and whose position information is acquired and used by the system.

The term “position information” refers to data representing a geographical location of the mobile body, including at least coordinate information such as latitude and longitude, and optionally time information and accuracy information.

The term “positioning device” refers to a hardware and/or software component configured to determine the geographical location of the mobile body, including but not limited to a satellite-based positioning receiver, a terrestrial positioning module, or a sensor fusion module that outputs position information.

The term “surrounding area” refers to a region defined with respect to the current position of the mobile body, such as an area within a predetermined distance or within a predetermined administrative boundary around the mobile body.

The term “information storage device” refers to any computer-readable storage medium or storage subsystem, such as a database system or file system, that stores sightseeing-related information and associated data in a machine-readable format.

The term “sightseeing-related information” refers to information associated with points of interest in a geographical region, including at least names, categories, outlines, and location information of tourist attractions, cultural facilities, commercial facilities, or food and beverage facilities.

The term “sightseeing object information” refers to sightseeing-related information that has been extracted or selected by the processor as candidate points of interest for guidance based on the position information and the surrounding area.

The term “structured information” refers to information that is organized according to a predefined data structure, such as records or fields, and that includes at least a name, a type, and an outline of each sightseeing object, thereby enabling programmatic processing and prompt generation.

The term “user attribute information” refers to information related to a user, including at least preference information, profile information, or usage history information, that can influence selection, prioritization, or presentation of sightseeing guidance.

The term “prompt sentence” refers to a machine-readable text input constructed by the processor, including structured information and context information, and supplied to a generative AI model for controlling generation of a sightseeing guidance natural language description.

The term “generative AI model” refers to a machine learning model configured to generate natural language text based on input data, such as a prompt sentence and associated parameters, by using statistical or neural network-based language generation techniques.

The term “sightseeing guidance natural language description” refers to a natural language text generated by the generative AI model that explains, introduces, or recommends sightseeing objects in a human-readable form suitable for presentation to a user.

The term “guidance information data” refers to a data set including at least the sightseeing guidance natural language description and the sightseeing object information, and optionally including coordinate information, distance information, and display-related metadata, formatted for transmission to and display on a user terminal.

The term “user terminal” refers to an information processing apparatus operated or viewed by a user, such as a mobile communication device, a portable terminal, or an in-vehicle display device, that receives and presents the guidance information data.

The term “generation history” refers to record information indicating when and under what conditions the guidance information data or sightseeing guidance natural language descriptions were generated by the processor and the generative AI model.

The term “transmission history” refers to record information indicating when and to which user terminal the guidance information data was transmitted, and optionally including status information of the transmission.

The term “coordinate information” refers to data indicating a geographic position of a sightseeing object, such as latitude and longitude, and optionally including altitude, coordinate system identifiers, or accuracy indicators.

The term “distance information” refers to data calculated based on the position information and the coordinate information of a sightseeing object, representing at least a distance or relative positional relationship between the mobile body and the sightseeing object.

The term “priority information” refers to data indicating an order or importance level of sightseeing objects, determined based on criteria such as distance information, user attribute information, or predetermined rules.

The term “display style instruction information” refers to information embedded in or associated with the prompt sentence that specifies desired presentation characteristics, such as grouping, emphasis, level of detail, or summarization style, for the sightseeing guidance natural language description.

The term “region name information” refers to information indicating a geographical or administrative name, such as a city name or area name, that is determined based on the position information or the surrounding area.

The term “category information” refers to information indicating a classification of a sightseeing object, such as a type of facility, genre, or thematic class, used to organize or filter sightseeing object information.

The term “preference information” refers to information indicating a user's interests or tendencies, such as favored categories, disliked categories, or historical selection patterns, which can be used to customize the sightseeing guidance.

The term “condition information regarding an output language and a writing style” refers to information specifying constraints or requirements for the natural language output, including at least the language, tone, length, level of detail, or format of the sightseeing guidance natural language description.

In one embodiment, a server implements the claimed system by executing a program on a general-purpose computing platform. The server includes at least one central processing unit (CPU), a main memory, a non-volatile storage device, a network interface, and an interface to a positioning device. The server executes an operating system such as a general-purpose server operating system and runs server application software that implements the functions of acquiring position information, managing a sightseeing information database, constructing a prompt sentence, communicating with a generative AI model, and transmitting guidance information to a terminal. The terminal includes a processor, a display device, an input device such as a touch panel, a memory, and a wireless communication module, and executes an operating system such as a mobile device operating system and an application program for receiving and displaying sightseeing guidance information. The user operates the terminal or views the display in a moving mobile body.

The server uses a positioning device mounted in the mobile body as hardware to acquire position information. The positioning device may be implemented by a satellite-based positioning module, for example a global navigation satellite system (GNSS) receiver module that outputs position information in a standard message format such as an NMEA sentence. The server receives latitude, longitude, and time information via an in-vehicle communication interface such as a controller area network (CAN) bus or an Ethernet-based telematics module. The server stores the received position information in a relational database management system, for example a database management program using a spatial extension. The database stores tables for sightseeing-related information, including a table for points of interest and a table for food and beverage facilities. Each table has fields such as an object identifier, a region identifier, a name, a category, a brief outline, coordinate information, and popularity scores.

The server uses spatial indexing and spatial query functions provided by the database software to efficiently search sightseeing object information around the current position. For example, the server uses a spatial index based on an R-tree structure in the database to accelerate calculation of distance between the position information and coordinate information of each sightseeing object. The server issues a query that selects records from the sightseeing-related information tables whose coordinates fall within a specified radius from the current position, and orders the records by distance or by a combination of distance and popularity score. The server thereby converts raw geographic sensor data into a structured, ranked list of sightseeing objects, which constitutes sightseeing object information.

The server generates structured information for each sightseeing object by extracting and normalizing data from the database. The structured information is represented as an internal data structure including fields such as object name, type (for example, temple, museum, restaurant), outline (short description), coordinates, distance from the current position, region name, and category labels. The server may store this structured information in a memory-resident data structure (for example, an array of records) that is optimized for subsequent prompt construction processing. By maintaining this explicit structured representation, the server enables the subsequent processing for prompt sentence generation and guidance formatting to avoid redundant database access and to take advantage of well-defined fields.

The server constructs a prompt sentence for a generative AI model by programmatically composing text from the structured information and user attribute information. The server retrieves user attribute information from a user profile table that stores preference information such as preferred categories (for example, historical sites, local food), language preference, and desired detail level. The server uses an algorithm that traverses the structured information and, for each sightseeing object, generates a line of descriptive context in a normalized pattern, for example “ObjectName: Category, short description, distance X km.” The server concatenates these lines, and adds explicit instructions about language, writing style, and ordering rules. The prompt sentence is not a simple concatenation of arbitrary text; instead, the server uses a rule-based template system that inserts priority information and display style instruction information derived from the distance information and user preferences.

For example, the server may generate a prompt sentence such as:
“Current location: a historic city in a certain country. The user is riding in an autonomous shared vehicle. Nearby spots from the database (sorted by distance and user preference for historical sites and local food): 1) A famous temple known for its wooden stage and panoramic city view, located approximately 1.2 km away. 2) A pavilion temple covered with gold-colored leaf beside a reflective pond, located approximately 3.5 km away. 3) A traditional district with wooden townhouses and classical entertainment culture, located approximately 2.0 km away. Local gourmet: tofu hot pot, simple but rich dish often served near temple districts; green tea sweets such as parfaits and cakes in nearby cafés. Please act as a travel guide and generate a concise, easy-to-understand explanation in the user's preferred language that introduces these spots and suggests what the user can enjoy while passing nearby, with more detail for closer spots and brief mentions for distant spots.”

As another example, the server may generate a follow-up prompt sentence focused on a single object:
“Current location: a historic city area. The user selected a specific temple. Database details: historical background, main architectural features, viewing platform, seasonal events. The user asked: ‘Please tell me more about the history in simple language.’ Please generate a short, clear historical explanation suitable for a tourist in an autonomous vehicle, in the user's preferred language, focusing on historical facts and avoiding unrelated information.”

The server uses a generative AI model that is implemented as a trained neural network language model. The generative AI model may be a transformer-based neural network that includes an embedding layer, a plurality of self-attention layers, and a final output layer that produces probability distributions over tokens in a vocabulary. The server supplies the prompt sentence to the generative AI model via an application programming interface exposed by an inference service running on one or more computing devices, such as graphics processing unit (GPU) servers or specialized accelerators.

The server configures the generative AI model using explicit inference parameters, including a temperature parameter controlling the randomness of token sampling, a maximum output length in tokens, and a top-k or top-p sampling parameter. The server uses these parameters to control the trade-off between diversity and determinism of the generated sightseeing guidance natural language description. The server receives the output token sequence from the generative AI model, decodes it into text, and performs validation checks such as detecting empty or excessively long responses, verifying that the output language matches the requested language, and optionally filtering inappropriate content using rule-based checks.

The generative AI model itself is trained in advance using a corpus that includes general language data and domain-specific texts related to sightseeing guidance. During training, the system uses a loss function such as cross-entropy between predicted token distributions and ground truth tokens, and updates the network weights using an optimization algorithm such as stochastic gradient descent with adaptive learning rates. The training process may include data augmentation techniques such as random rephrasing of sightseeing descriptions, variation of prompt directives, and introduction of region-specific vocabulary, so that the model acquires robust ability to generate coherent, context-aware guidance. By training the generative AI model in this manner, the system improves the quality and consistency of generated guidance compared to simple template-based or manually curated text.

The server formats guidance information data by combining the sightseeing guidance natural language description with sightseeing object information and associated metadata. The guidance information data is represented as a structured message that the terminal can parse, including fields for the full text description, object identifiers, coordinates, distances, region names, categories, and display hints. The server may generate shortened summary segments for notification use and expanded segments for detailed views. The server stores generation history information in a log table, linking each generated guidance item to the corresponding position information, prompt sentence, and model parameters used. The server also stores transmission history, indicating which terminal received which guidance item and at what time.

The server uses the generation history and transmission history to avoid redundant generation and transmission. When the position information changes within a small threshold and the corresponding sightseeing object list remains stable, the server can reuse existing guidance information data or partially update only the distance information without invoking the generative AI model. This reduces processing load on the GPU servers and lowers latency. When the server detects that the mobile body has moved into a different region or that the set of nearby sightseeing objects has significantly changed, the server triggers generation of a new prompt sentence and a new sightseeing guidance natural language description. Because the server uses structured information and priority information, the prompt sentence is tightly constrained and optimized for each situation, leading to more efficient and accurate text generation.

The terminal receives the guidance information data via a communication network such as a cellular network or wireless local area network. The terminal uses network communication libraries provided by the operating system to establish secure connections with the server. The terminal stores the received data in a local database or memory cache, and interprets the structured fields to determine how to present the information on the display. The terminal may display a notification banner containing a summary text and, upon user interaction, present a detailed screen that shows the full sightseeing guidance natural language description, a list of objects sorted by distance, and a map view with markers at the coordinates of each sightseeing object. The terminal uses a map rendering library to display map tiles and overlay markers, and reads the coordinates from the guidance information data.

The user views the display on the terminal while riding in the mobile body. The user may select one of the objects to request further details, change preference settings such as preferred categories or detail level, or switch display language. The terminal sends these user requests to the server, which in turn modifies the prompt sentence construction procedure accordingly. For example, if the user sets a preference for food-related information, the server increases the priority of food and beverage facilities in the sightseeing object list and adjusts the prompt sentence to request more detail about local cuisine and less about historical background. In this way, the system dynamically adapts to user input without requiring manual composition of new guidance texts by human operators.

From a technical perspective, the server improves computer technology in several ways. By maintaining a structured representation of sightseeing object information and explicitly encoding priority information and display style instruction information into the prompt sentence, the server reduces the amount of post-processing and filtering required on the terminal, thus saving computational resources on the terminal side. Because the prompt sentence is constructed using normalized templates and explicit metadata, the generative AI model can focus on generating coherent narrative text rather than implicitly inferring context, which leads to higher accuracy and reduced variance in output, thereby reducing the need for repeated requests and retries. The server's use of spatial indices and distance-based ranking increases query performance for dynamic, moving positions, thereby improving overall processing speed.

In addition, the server's logging of generation history and transmission history allows it to implement caching and reuse strategies that reduce redundant invocation of the generative AI model. This results in reduced processing time and lower resource consumption on the server hardware, especially for large-scale deployments with many mobile bodies. The combination of structured prompt construction, history management, and conditional regeneration enables fine-grained control over when and how new guidance is generated, which is not achievable by simple human-like manual writing or naive automation. This combination improves processing efficiency and stabilizes latency across varied network conditions.

The generative AI model, being trained and used as described above, processes input in a manner distinct from conventional human text generation. The model encodes the prompt sentence into a high-dimensional feature vector using learned embeddings, applies multi-head self-attention to capture relationships between different parts of the prompt, and computes output token probabilities based on learned weight matrices. The model does not follow fixed human-authored rules; instead, it uses a learned mapping from input sequences to output sequences, optimized with respect to an error function. This allows the system to consider complex interactions between region name information, category information, preference information, and condition information regarding output language and writing style without requiring explicit if-then rules for each combination.

Because the server prepares the prompt sentence with explicit fields, the generative AI model can exploit its internal attention mechanism to attend to relevant parts, such as distance information or user preferences, when choosing words and organizing sentences. This leads to more targeted and concise descriptions, improving comprehension for the user and reducing the size of transmitted data, which in turn reduces communication load. The system thus exhibits a technical effect where structured prompt design and history-aware regeneration contribute to improved processing speed, reduced bandwidth usage, and more accurate, contextually consistent outputs compared to systems that simply send raw location data and unstructured text fragments to a generic language model.

Alternative embodiments are also possible. The server may use a different type of generative AI model, such as a recurrent neural network with an attention mechanism, provided that the model accepts a prompt sentence and generates a sightseeing guidance natural language description. The server may deploy the generative AI model locally on the same hardware as the database, or remotely on a separate inference cluster. The positioning device may be augmented by inertial sensors and map matching algorithms, so that the server can refine the position information and further increase the accuracy of surrounding area specification. The terminal may be an in-vehicle display unit integrated with the vehicle control system, where the guidance information is synchronized with vehicle motion or audio output.

In another embodiment, the server may adjust the sampling parameters of the generative AI model dynamically in response to processing load or network conditions. For example, when network latency is high, the server may reduce maximum output length and adjust the temperature to generate shorter, more deterministic outputs, reducing transmission size and response time. When the mobile body is stationary or moving slowly, the server may permit longer, more detailed output to enrich the user's experience. These dynamic adjustments are computed by the processor based on system metrics and are reflected in the prompt sentence and the model parameters, thereby constituting a technical control mechanism for balancing quality and performance.

By combining these elements, the server and terminal cooperate to implement a concrete, machine-implemented sightseeing guidance system that uses a generative AI model not merely to automate human writing but to improve internal data representation, prompt construction, and resource management. The system efficiently converts continuous streams of position information into structured sightseeing object information, generates context-aware prompt sentences that are precisely tailored for neural text generation, and delivers optimized guidance information data to the terminal. As a result, the system realizes technical effects such as improved processing speed, reduced communication load, enhanced accuracy of generated guidance, and more stable synchronization between server and terminal, which together constitute an improvement in computer technology in the field of location-based guidance and generative AI-assisted information delivery.

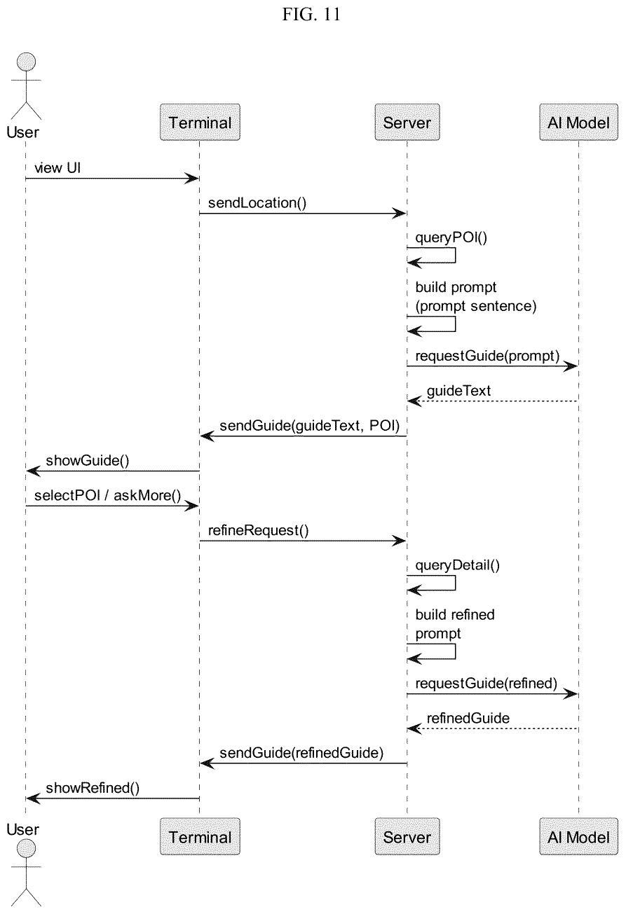

The following describes the processing flow using FIG. 11.

### Step 1:

The server acquires position information of a mobile body.

The server receives, as input, raw positioning messages from a positioning device mounted in the mobile body, for example NMEA sentences containing latitude, longitude, timestamp, and quality indicators. The server parses these messages, converts the latitude and longitude into decimal degrees, normalizes the timestamp to a unified time format, and discards invalid readings based on quality flags or out-of-range coordinates. As output, the server generates normalized position information records containing at least a vehicle identifier, current coordinates, time, and validity flags, and stores these records in a position log table in a database.

### Step 2:

The server identifies a surrounding area and searches sightseeing-related information.

The server takes the normalized position information as input and computes a surrounding area, for example a circular region with a predetermined radius centered at the current coordinates. The server then executes a spatial query against a sightseeing information database, using the current coordinates as parameters, to retrieve sightseeing-related entries whose coordinate fields fall within the surrounding area. During this processing, the server uses spatial indices and distance calculation functions to filter and rank candidate entries. As output, the server produces sightseeing object information, which is a list of records including object identifiers, names, categories, outlines, coordinates, and preliminary distance values from the current position.

### Step 3:

The server calculates distance and priority for each sightseeing object.

The server uses the current coordinates and the coordinates of each sightseeing object as input. The server applies a geographic distance calculation algorithm, such as a haversine formula or a planar approximation, to obtain a numeric distance between the mobile body and each sightseeing object. The server then computes priority information by applying predetermined rules that combine distance values, popularity scores stored in the database, and user preference weights obtained from a user profile. As output, the server updates each sightseeing object record with a refined distance value and an associated priority score, and sorts the list according to the priority score.

### Step 4:

The server generates structured information for sightseeing objects.

The server takes the prioritized sightseeing object list as input and constructs structured information for each object. The server extracts fields such as name, type, outline, coordinates, distance, category labels, and region identifiers, and normalizes the outline text to a length suitable for prompt inclusion by truncating or summarizing it according to predefined rules. The server then organizes these fields into an internal data structure, for example an array of records with fixed field names, that can be easily traversed during prompt sentence construction. As output, the server produces a structured information set representing the nearby sightseeing objects in a machine-readable and prompt-ready form.

### Step 5:

The server retrieves user attribute information.

The server receives, as input, a user identifier associated with the current session or vehicle.

The server queries a user attribute storage, such as a user profile table, to fetch preference information (for example, preferred categories, disliked categories), language settings, and desired detail level. The server may also incorporate recent user interactions, such as previously selected spots, as additional preference indicators. As output, the server generates a user attribute information object containing normalized preference weights, language codes, and content-length constraints to be used in subsequent processing.

### Step 6:

The server constructs a prompt sentence for a generative AI model.

The server uses the structured information set and the user attribute information as input. The server selects a subset of sightseeing objects based on priority scores and user preferences, and then applies a template-based text generation algorithm to create descriptive lines for each object, such as “ObjectName: category, short outline, distance X km.” The server concatenates these lines, prefixes region name information derived from the position information, and appends explicit instructions regarding output language, writing style, and emphasis rules (for example, “more detail for closer spots”). The server also inserts display style instruction information, such as grouping by category or ordering by distance. As output, the server produces a complete prompt sentence text that encapsulates structured context and control information for the generative AI model.

### Step 7:

The server sends the prompt sentence to the generative AI model and obtains a sightseeing guidance natural language description.

The server uses the prompt sentence as input and issues an inference request to a generative AI model through an application programming interface. The server specifies inference parameters such as temperature, maximum token count, and sampling strategy, and transmits the prompt sentence over a network connection to a model inference service. The generative AI model processes the prompt sentence and returns a sequence of output tokens representing a sightseeing guidance natural language description. The server decodes the tokens to text and performs validation, such as checking the language, length, and basic consistency with the prompt constraints. As output, the server obtains a validated sightseeing guidance natural language description aligned with the structured context.

### Step 8:

The server formats guidance information data.

The server takes, as input, the sightseeing guidance natural language description and the structured information set for the sightseeing objects. The server constructs a guidance information data object containing the full text description, a list of sightseeing object identifiers, coordinates, distances, region names, categories, and any display hints derived from user preferences. The server may also generate shorter summary fragments for notifications and link them to the full description. As output, the server generates a structured guidance information data payload, for example an internal message object ready for serialization and transmission to the terminal.

### Step 9:

The server records generation history and transmission control information.

The server uses the guidance information data, the prompt sentence, and the current position information as input. The server creates a generation history record that associates the generated sightseeing guidance natural language description with the position coordinates, the list of sightseeing objects, and the inference parameters used. The server stores this record in a history table. The server also prepares a transmission control entry that marks the guidance information data as pending for a particular terminal session. As output, the server generates persistent history records that will be used to determine whether regeneration is necessary when new position information is received.

### Step 10:

The server transmits the guidance information data to the terminal.

The server takes the guidance information data and the terminal identifier as input. The server serializes the data into a transmission format, establishes a secure communication channel with the terminal, and sends the serialized payload. The server monitors the transmission status and updates the transmission history record with success or failure flags and timestamps. As output, the server produces updated transmission history data and ensures that the terminal receives the latest guidance information corresponding to the current or recent position.

### Step 11:

The terminal receives and parses the guidance information data.

The terminal accepts, as input, the serialized guidance information data sent by the server. The terminal uses a communication library to read the payload, validate its integrity, and deserialize it into internal data structures. The terminal separates the main sightseeing guidance natural language description, the list of sightseeing objects, coordinates, distances, and display hints. The terminal may compare the timestamp of the received data with previously stored guidance to decide whether to replace older information. As output, the terminal produces an internal representation of the guidance information that is ready for display and user interaction.

### Step 12:

The terminal presents sightseeing guidance to the user.

The terminal takes the internal representation of the guidance information as input and renders it on a display device using a graphical user interface framework. The terminal uses the summary fragment to show a notification banner and, upon user interaction, displays the full sightseeing guidance natural language description in a detailed view, alongside a sorted list of sightseeing objects and a map with markers at the corresponding coordinates. The terminal uses distance values and display hints to adjust font size, ordering, or grouping. As output, the terminal presents visual and optionally audio guidance content that the user can perceive while the mobile body is moving.

### Step 13:

The user interacts with the displayed guidance.

The user receives, as input, the guidance content on the terminal display and performs operations such as tapping a specific sightseeing object, requesting more detailed information, or changing preference settings. The user may select a “more details” option for a particular sightseeing object or choose to focus on a particular category, such as local food. As output, the user generates input events on the terminal, which are captured as commands specifying selected object identifiers, updated preferences, or new information requests.

### Step 14:

The terminal sends a refinement request to the server.

The terminal uses the user's interaction events and the currently displayed guidance information as input. The terminal constructs a refinement request that includes the user identifier, selected sightseeing object identifier, updated preference information, and a textual request such as “tell me more about the history in simple language” or “focus on nearby food recommendations.” The terminal transmits this refinement request to the server via the established communication channel. As output, the terminal produces a well-defined request message that the server can use to generate a refined prompt sentence.

### Step 15:

The server generates a refined prompt sentence and updated guidance.

The server receives, as input, the refinement request, including the selected object identifier and updated user preferences. The server queries the database for detailed information about the selected object, such as historical background, architectural features, or menu details, and combines this with the updated user preference information. The server constructs a refined prompt sentence that explicitly instructs the generative AI model to focus on the requested aspects, for example history or gourmet information, and to use the user's preferred language and level of detail. The server then sends this refined prompt sentence to the generative AI model, obtains a new sightseeing guidance natural language description, and formats updated guidance information data. As output, the server produces refined guidance tailored to the specific object and user request.

### Step 16:

The terminal updates the displayed guidance based on the refined output.

The terminal receives, as input, the refined guidance information data from the server. The terminal parses the updated content, replaces or supplements the previous description for the selected sightseeing object, and refreshes the display to show the refined sightseeing guidance natural language description. The terminal may highlight newly added details or adjust the layout according to updated display hints. As output, the terminal provides the user with more precise, context-aware information without requiring manual text composition, completing a feedback loop that uses the generative AI model and prompt sentence refinement to improve the guidance experience.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented sightseeing guidance systems that operate in vehicles typically rely on static rule sets or pre-authored content that is selected solely based on coarse location information and simple user profile attributes. In such systems, a server generally retrieves points of interest from a database based on the current geographic coordinates and transmits fixed descriptions to a user terminal. As a result, these systems suffer from several technical limitations in terms of information processing and interaction control.

First, conventional systems are not configured to generate and update guidance content in real time based on continuous streams of sensor data, such as frequently updated position information and operation state information of a moving body. The server processing pipeline is often designed for one-time lookup and display, and does not efficiently handle dynamic regeneration of candidate lists and detailed guidance information as the moving body travels. This leads to stale or context-mismatched content, and forces the user terminal to repeatedly request full updates, resulting in redundant network traffic and inefficient utilization of computing resources.

Second, conventional systems do not integrate generative AI models into the core of the server-side decision flow in a way that uses structured, machine-generated prompt sentences that aggregate heterogeneous context, such as user preferences, current position, route information, and database-stored attributes of candidate locations. Instead, naive approaches send loosely formatted, human-oriented text to a generative AI model, which causes non-deterministic responses, makes server-side control of the content difficult, and complicates caching, logging, and safety checks. This lack of prompt structuring results in unstable personalization quality and increases the computational cost of retrying or post-filtering outputs.

Third, typical sightseeing guidance platforms do not maintain a dialog context that is bound to both current and historical system state, including previously generated AI outputs, selected spots, and current travel route. User inquiries entered at the terminal are often processed as isolated questions, without structured linkage to stored context in the server. This forces the server to recompute or re-retrieve large amounts of information, introduces latency, and prevents the system from reusing prior computations, which degrades responsiveness and scalability when many users are served concurrently.

Fourth, the presentation timing, level of detail, and expression style of the guidance are rarely optimized in conjunction with real-time operation states of the moving body. The server typically does not convert low-level sensor signals into control conditions that directly influence both the prompt sentences for the generative AI model and the layout and verbosity of the guidance delivered to the terminal. Consequently, content may be delivered at inappropriate times (for example, during maneuvers that require user attention) or with unsuitable granularity, and the server cannot systematically manage this behavior through software logic.

Therefore, there is a need for an improved computer-implemented system and server-side processing architecture that: (i) continuously integrates updated position and operation state information of a moving body into the generation and regeneration of candidate lists and detailed guidance information; (ii) constructs structured prompt sentences that encode database-derived attributes, user preference data, and travel context as machine-readable inputs to a generative AI model; (iii) maintains and exploits dialog context in the server to answer follow-up inquiries efficiently; and (iv) uses sensor-derived control conditions to dynamically adapt both AI prompt content and output presentation, thereby improving the technical performance, responsiveness, and resource efficiency of the sightseeing guidance computation.

The specific processing by the specific processing unit 290 of the data processing device 12 in Application Example 1 is realized by the following means.

The present invention provides a server comprising a processor and a memory storing instructions which, when executed by the processor, cause the server to control a moving body to provide an autonomous travel function, to communicate with a shared-use service for the moving body to exchange reservation information and usage status information and to manage the reservation information and the usage status information, to acquire position information from a positioning device and specify a current position of the moving body based on the position information, to search an information storage device, based on the current position, for candidates of stay targets existing in a vicinity of the current position and generate candidate list information including the candidates of the stay targets, to transmit the candidate list information to a communication terminal and output information including identification information for each of the stay targets, the information being usable by the communication terminal to perform display control and to receive, from a user, a selection operation on the candidates of the stay targets, to receive, from the communication terminal, the identification information corresponding to the selection operation and acquire attribute information and position information of a stay target associated with the identification information from the information storage device, to generate document data including preference information and state information regarding the user, the current position, the attribute information and the position information of the stay target, travel route information, and required time information, and configure the document data as a structured prompt sentence to be input to a generative information processing model, to input the prompt sentence to the generative information processing model and obtain, from the generative information processing model, a generation result including personalized guidance information and itinerary proposal information relating to the stay target, to integrate the generation result with basic information stored in the information storage device to generate detailed guidance information and transmit the detailed guidance information to the communication terminal to cause the communication terminal to present the detailed guidance information, to regenerate, based on position information that is updated while the moving body is traveling, at least one of the candidate list information and the detailed guidance information in accordance with a predetermined condition, to dynamically update contents of the prompt sentence and use the updated prompt sentence as an input to the generative information processing model, to acquire state information from a detection device that detects an operation state of the moving body and determine, based on the state information, control conditions indicating at least one of timing, level of detail, and expression format of information presentation to the user and reflect the control conditions in the prompt sentence and the detailed guidance information, and to accept input operations from the user and inquiry content regarding the detailed guidance information, generate a dialogue prompt sentence by combining the inquiry content with context information relating to the current position, the stay target, and past generation results, re-input the dialogue prompt sentence to the generative information processing model to obtain response information, and transmit the response information to the communication terminal. This enables the server to implement a technically improved, context-aware sightseeing guidance pipeline that continuously incorporates real-time sensor data and database information into structured prompt sentences for a generative AI model, dynamically regenerates and personalizes guidance content while conserving communication and computation resources, and adaptively controls the timing, granularity, and style of information presentation in response to both user interactions and operation states of the moving body.

The term “moving body” refers to a transport apparatus that is configured to move in a physical space, such as a vehicle, and that can be controlled by an electronic control unit to provide at least partially autonomous travel.

The term “autonomous travel function” refers to a control function that enables the moving body to travel along a route without continuous manual steering, acceleration, or braking operations by a human operator, based on sensor inputs and control algorithms executed by a processor.

The term “shared-use service” refers to an information processing service that manages the allocation, reservation, and usage of one or more moving bodies by a plurality of users, including storage and update of reservation information and usage status information.

The term “reservation information” refers to data indicating at least a user's booking for use of a moving body, including one or more of a user identifier, a vehicle identifier, a planned start time, a planned end time, a pick-up location, and a destination location.

The term “usage status information” refers to data indicating a current or past state of use of a moving body, including one or more of an in-use flag, a current user identifier, a current route, a remaining travel time, and a current operating mode.

The term “position information” refers to data indicating a location of the moving body or the user in a coordinate system, such as latitude and longitude values obtained from a positioning device, optionally including altitude, speed, and heading.

The term “positioning device” refers to a hardware and software combination that is configured to detect a geographic position, such as a satellite positioning receiver, an inertial measurement sensor system, or a combination thereof.

The term “current position” refers to a geographic position of the moving body or the user determined at a given time based on position information acquired from the positioning device.

The term “information storage device” refers to a hardware-implemented storage resource, such as a memory or a database, that stores data records including at least stay targets, attribute information, user profiles, and route information.

The term “stay target” refers to a location or facility that is a candidate destination or place to be visited by the user, including at least sightseeing locations, facilities providing goods or services, and points of interest.

The term “candidate list information” refers to structured data representing a plurality of stay targets that satisfy a search condition, the data including at least an identifier for each stay target and optionally including additional attributes such as a name, a category, and a distance.

The term “communication terminal” refers to an electronic device operated by the user, such as a portable information terminal, that can communicate with the server, receive data, present information, and accept user input.

The term “identification information” refers to data that uniquely or distinctly identifies a stay target, a user, a session, or another entity within the system, such as an identifier value assigned in the information storage device.

The term “attribute information” refers to data describing properties of a stay target, including one or more of a name, a category, an address, opening hours, a price range, a rating, descriptive text, and tags.

The term “preference information” refers to data representing at least one tendency or interest of the user, including preferred categories of stay targets, preferred activity styles, budget ranges, time constraints, and language preferences.

The term “state information regarding the user” refers to data indicating a current or recent condition of the user relevant to information presentation, including one or more of a fatigue level, a travel purpose, a current interaction mode, or a current location within the moving body, as derived from input, sensors, or stored profiles.

The term “travel route information” refers to data representing a planned or current path of movement of the moving body, including at least a sequence of positions, an estimated travel time, and route attributes such as road types.

The term “required time information” refers to data indicating estimated times needed to move between locations or to complete visits to stay targets, including at least travel duration and optional stay duration.

The term “document data” refers to structured or semi-structured digital data that includes multiple fields of information, such as user preferences, position information, attribute information, and route information, arranged so as to be processable as input to a generative model.

The term “prompt sentence” refers to text or structured data that encodes an instruction, context, and constraints for a generative information processing model, and that is provided as an input to cause the model to generate output content.

The term “structured prompt sentence” refers to a prompt sentence in which the instruction, context, and constraints are arranged according to a predefined machine-readable structure, such as a template or a fielded data format, to enable deterministic parsing and processing by the server and the generative information processing model.

The term “generative information processing model” refers to a parameterized computational model, such as a machine learning model, that is configured to generate new data, including natural language text, based on input data including a prompt sentence.

The term “generation result” refers to data output by the generative information processing model in response to a prompt sentence, the data including at least natural language text that reflects the instruction and context contained in the prompt sentence.

The term “personalized guidance information” refers to guidance content generated or selected for a specific user based on the user's preference information, state information, and current context, and that is included in the generation result.

The term “itinerary proposal information” refers to generated content describing a proposed sequence of visits to one or more stay targets, including suggested order, timing, and optionally recommended durations and transitions.

The term “basic information” refers to non-generated, factual data stored in the information storage device, including at least attribute information, route data, and predefined descriptive content for stay targets.

The term “detailed guidance information” refers to information generated by integrating the generation result from the generative information processing model with basic information from the information storage device, to produce a comprehensive presentation for a stay target or a route.

The term “predetermined condition” refers to at least one rule or threshold used by the server to decide whether to regenerate candidate list information or detailed guidance information based on updated position information, such as a distance threshold, a time threshold, or a change in user state.

The term “detection device” refers to a sensor or a sensor system configured to detect an operation state of the moving body, including at least one of speed, acceleration, steering angle, or control mode.

The term “operation state of the moving body” refers to a state of motion or control of the moving body detected by the detection device, including at least one of traveling, stopping, turning, or changing lanes, and an associated safety or attention level.

The term “control conditions” refers to parameters derived from the operation state of the moving body and other context that specify at least one of timing, level of detail, and expression format of information presentation to the user.

The term “expression format of information presentation” refers to a manner in which guidance information is expressed and output, including at least one of text length, summarization level, tone, language, and segmentation into items.

The term “dialogue prompt sentence” refers to a prompt sentence that is constructed for interactive exchange, including user inquiry content and context information relating to at least the current position, stay targets, and past generation results, and that is provided to the generative information processing model to obtain a response in a conversational manner.

The term “response information” refers to content generated by the generative information processing model in response to a dialogue prompt sentence, including at least an answer to a user inquiry and optionally follow-up suggestions.

In one embodiment, a server, a terminal, and a moving body cooperate to implement a context-aware sightseeing guidance system using a generative AI model driven by structured prompt sentences. The server executes a program on hardware resources such as a multi-core CPU, a main memory, a non-volatile storage device, and a network interface. The server may be realized by a general-purpose computer or a virtual machine instance in a cloud environment. The terminal is realized by a portable information device, such as a smartphone or a tablet, including a display, a touch input interface, a wireless communication module, and a local storage. The moving body is realized by a vehicle equipped with an electronic control unit, a positioning device, and an operation-state detection device.

The server executes an operating system, such as a UNIX-like operating system, and an application platform including a web application framework and a database management system. The server uses a relational database to store reservation information, usage status information, stay targets, user profiles, route information, and historical generation results. The database stores, for each stay target, attribute information such as a unique identifier, a name, a category, coordinate data, opening hours, tags, and basic descriptive text.

The server communicates with the moving body via a communication network. The server receives position information from the positioning device of the moving body. The positioning device measures latitude, longitude, and optionally heading and speed, and provides the data in a standard format such as NMEA or a lightweight binary or JSON format. The server parses the incoming data, validates ranges and timestamps, and stores the result in the database in an indexed location table. The server also communicates with a shared-use management system that manages reservation information and usage status information for multiple moving bodies. The server accesses reservation and usage data in order to identify a user, a current route, and a planned destination.

The server further receives operation-state information from the detection device of the moving body. The detection device may comprise one or more of a wheel speed sensor, an accelerometer, a steering angle sensor, a brake sensor, and a control-mode flag. The server stores sampled operation-state vectors in a time-series table. The server derives, from these vectors, control conditions such as a recommended timing for showing long explanations, a recommended level of detail, and an expression format for information presentation. For example, the server sets a flag indicating that only short summaries should be displayed when the moving body is accelerating or turning sharply, and allows longer, more detailed explanations when the moving body is traveling at constant speed on a straight route.

The server maintains a data structure that represents candidate list information. In one embodiment, the server uses a table or an in-memory structure where each record contains a stay target identifier, coordinates, a distance from the current position, and a score representing relevance for the user. The server computes the distance using a geographic distance formula, and computes the score as a weighted sum of normalized features such as distance, popularity, category match with the user's preference information, and suitability with respect to time of day. This scoring algorithm is executed by the server and stored in the program. The server stores the candidate list information in memory and also writes a snapshot to the database to allow later reuse.

The server uses the candidate list information to generate data for display on the terminal. The server constructs an output including, for each candidate stay target, the identifier, name, category, distance, and a shortened version of the descriptive text. The server transmits this output to the terminal over a network using a request-response protocol. The output is structured so that the terminal can directly map each field to user interface widgets, thereby reducing parsing overhead and minimizing re-rendering on the terminal.

The terminal executes an application that maintains a local model of the current candidate list and detailed guidance information. The terminal receives candidate list information from the server and stores it in local memory. The terminal displays each stay target in a scrollable list on the display. The terminal accepts a tap operation or a similar user interaction as a selection of a stay target. The terminal identifies the selected stay target identifier and transmits the identifier to the server.

The server maintains a user profile that includes preference information and state information regarding the user. The preference information may specify preferred categories of stay targets, preferred walking distances, budget ranges, and language preference. The state information may include a current interaction mode, such as a “short summary mode” or a “detailed explanation mode”, determined based on recent user interactions and operation-state conditions. The server uses this profile information, together with the current position, the selected stay target, and route information, to construct document data.

The server generates document data as a multi-field object including, at least, (i) the current position and current time, (ii) the selected stay target's attribute information and position information, (iii) a planned travel route between the current position and the stay target and an estimated required time, (iv) the user's preference information and state information, and (v) control conditions derived from operation-state information. The server then constructs a prompt sentence by mapping these fields to predefined textual segments. In one embodiment, the server uses a template that concatenates an instruction part, a context description part, a list of constraints, and a desired output format description. This explicit structuring of the prompt sentence, driven by structured document data, enables the server to generate prompts in a deterministic and machine-verifiable manner.

The server then inputs the prompt sentence to a generative AI model that is executed on specialized hardware such as a graphics processing unit or a tensor processing unit. In one embodiment, the generative AI model is realized as a transformer-based neural network that includes multiple attention layers, feed-forward layers, and layer normalization components. The model is trained as a language model to predict a next token given previous tokens. The model parameters are stored on a model server and accessed through an API.

During model training, a training process minimizes a cross-entropy loss between predicted token distributions and ground-truth tokens on a large text corpus that includes travel guides, conversational data, and structured descriptions. A gradient-based optimization method such as stochastic gradient descent with adaptive learning rate is used to update model weights, including attention matrices and feed-forward layer parameters. Regularization methods such as dropout and weight decay are applied to avoid overfitting. In some cases, the model is further fine-tuned on domain-specific data that includes annotations of good sightseeing explanations, recommended itineraries, and safety-compliant phrasing. The training process stores the resulting weight matrices in non-volatile memory on the model server.

The server uses the generative AI model at inference time by encoding the prompt sentence into token identifiers using a tokenizer. The server feeds the token identifiers to the neural network in sequence. Each layer of the network computes intermediate representations and attention weights. The server receives from the model a sequence of output token probabilities and samples or decodes a final sequence of tokens according to a decoding strategy, such as beam search or nucleus sampling with a predetermined temperature parameter. The server then decodes the tokens back into text, which constitutes a generation result.

The server uses specific features in the prompt sentence to constrain model behavior. For example, the server inserts an explicit instruction that the model should output numbered steps, mention walking times, and avoid recommending locations beyond a given distance threshold. The presence of these tokens causes the model's attention mechanism to bias its output toward the requested structure and content. This behavior is not a mere automation of human work because the server constructs internal machine-readable structures and uses them to manipulate attention patterns in the generative model in a repeatable way, thereby improving consistency, latency, and resource utilization.

One example of a prompt sentence generated by the server is as follows:
“You are a travel guide AI. The user is currently in Arashiyama, Kyoto, riding in an autonomous vehicle. The user has selected the spot ‘Arashiyama Bamboo Grove’. The user likes traditional temples and local Japanese sweets, and prefers walking routes under 2 hours. Based on the following factual data, create a friendly and easy-to-understand explanation of the spot and suggest how to enjoy it, including recommended times and nearby sweets shops: [factual data here].”
Another example of a user-initiated prompt sentence, processed and extended by the server, is as follows:
“My current location is Arashiyama. I have about 3 hours, and I like temples and traditional Japanese sweets. Please recommend a walking route including sightseeing spots and gourmet places, and explain why you chose them.”
The server may also generate a dialogue prompt sentence based on a follow-up inquiry, such as:
“I chose the Arashiyama Bamboo Grove and Togetsukyo Bridge. Please give me easy-to-understand historical background and the best time of day for photos.”

The server embeds such user text into a larger dialogue prompt sentence that also includes identifiers of previously selected stay targets, previously generated output summaries, and contextual route information.

The server integrates the generation result with basic information in the database. The server stores basic attribute information and route information in normalized tables, each with primary keys and foreign keys. The server retrieves the pertinent records and combines them with the generated text into a detailed guidance object. The server applies post-processing rules, such as verifying that recommended stay targets in the generated text exist in the database and that proposed travel times do not exceed physical constraints. The server thereby ensures that the detailed guidance information respects system constraints and remains coherent with database records.

The terminal receives the detailed guidance information and constructs user interface elements accordingly. The terminal displays generated text and basic information side by side, and may show a dynamic map visualization of the route. The terminal uses the control conditions supplied by the server to determine whether to display a shortened summary or a full description, and whether to present images and maps immediately or only on demand. The terminal thus adapts the user interface in coordination with server-side logic and operation-state conditions, improving safety and reducing cognitive load on the user.

The server continuously receives updated position information while the moving body is traveling. The server maintains a sliding window of recent positions and calculates a displacement and time difference between samples. If a predetermined condition is met, for example if the moving body has moved more than a certain distance or deviated from a planned route, the server regenerates the candidate list information and, if needed, triggers regeneration of detailed guidance information. When regenerating, the server takes into account cached generation results and database indexes. The server avoids recomputing unchanged portions of the guidance and reuses earlier generation results where possible, updating only sections that depend on the changed position or route. This partial recomputation reduces CPU load, reduces calls to the generative AI model, and thereby reduces overall latency and network traffic.

The server also manages a dialogue context for each user session. The server stores, in a session table, identifiers of previously selected stay targets, excerpts of generated guidance, and metadata describing the prompt sentences and responses. When the user inputs a new inquiry through the terminal, the server retrieves the relevant session data, extracts salient context, and forms a dialogue prompt sentence that includes both the new inquiry and prior context. This allows the generative AI model to produce coherent follow-up answers without requiring the user to restate all prior information, and allows the server to avoid recomputing the entire context each time. Maintaining this structured context at the server side is a specific data management technique that improves computational efficiency and throughput under high user load.

From a technical perspective, the described system improves computer technology rather than merely automating existing human tasks. The server uses structured prompt sentences, explicit control conditions, and context management to regulate the behavior of a large generative model in a resource-efficient and predictable manner. This architecture enables the system to adapt output length and detail to real-time operation-state data, thereby reducing unnecessary data transmission and rendering operations. The server's scoring and filtering of stay targets at the database level, before invoking the generative model, reduces the number of candidates that must be handled by the model. This selective invocation reduces computation time and energy consumption. Furthermore, the server's partial recomputation and caching of generation results prevents redundant model inference, which would otherwise consume considerable processing resources.

The integration of operation-state information into prompt generation yields additional technical effects. By using operation-state vectors to compute control conditions that directly influence both the timing and the form of guidance, the server can systematically avoid long or complex messages during high-load driving conditions. This not only improves safety but also optimizes the allocation of processing and communication capacity because the server can schedule heavy generation tasks when the moving body is in a stable state. This scheduling is achieved by concrete rules implemented in the server, rather than by a human operator.

The generative AI model itself is trained and configured in a manner tailored to the described application. The model uses embeddings that encode domain-specific tokens for categories of stay targets, time-of-day hints, weather hints, and safety constraints. During fine-tuning, the server (or an associated training unit) uses a loss function that penalizes outputs that violate distance constraints or recommend travel beyond a given time budget. This is realized by adding constraint-violation penalties to the standard language modeling loss. The training process therefore shapes the model to respect system constraints when influenced by structured prompt sentences. This is not simply replacing a person writing a travel guide, but constitutes an improvement in how the computing system itself represents and enforces constraints through learned parameters and structured prompts.

In another embodiment, the generative AI model is deployed locally within the same physical server as the database and application logic. In this case, the server uses a shared memory interface to feed prompt token sequences directly to the model, avoiding network overhead associated with remote model invocation. This reduces latency and allows tighter integration of the model's internal state with the application's context management. In still another embodiment, multiple models are used, such as a smaller model for quick, low-detail responses and a larger model for rich, detailed guidance. The server selects which model to call based on control conditions and user preferences, thereby trading off between latency and richness of output.

The system architecture is modular. The server comprises a position processing module, a candidate search module, a prompt construction module, a generative inference module, a guidance integration module, a context management module, and a presentation control module. Each module has clearly defined input and output data structures, such as coordinate vectors, candidate lists, profile objects, prompt sentences, generation results, and detailed guidance objects. This modular construction allows alternative implementations. For example, the position processing module may use different positioning devices or filters, and the candidate search module may use grid-based indexing instead of a conventional spatial index; however, each module continues to support the structured prompt generation and context-aware guidance pipeline as defined in the claims.

In summary, the server, terminal, and moving body cooperate in a specific, technically-oriented architecture. The server uses structured prompt sentences, operation-state-dependent control conditions, and context-aware management of generated content to drive a generative AI model efficiently and safely. The terminal implements adaptive display logic based on the control conditions and content type. The moving body provides real-time position and operation-state information that directly influences computation and communication patterns. This combination produces technical effects such as improved responsiveness, reduced redundant computation, optimized communication traffic, and safer, contextually appropriate information presentation, thereby enabling others skilled in the art to implement the claimed invention.

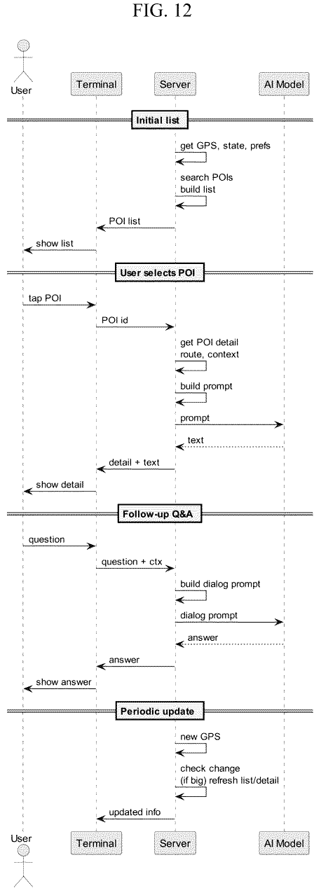

The following describes the processing flow using FIG. 12.

### Step 1:

The server acquires raw position information from the moving body.

The input is sensor data from a positioning device, including at least latitude, longitude, timestamp, and optionally speed and heading.

The server parses the sensor data, validates numerical ranges and timestamp freshness, and converts the data into a normalized coordinate record. The server writes this record into a location table in a database, indexed by a vehicle identifier and time.

The output is a current position object stored in memory and persistently stored coordinates in the database that are usable by subsequent modules.

### Step 2:

The server determines a current position and a travel context.

The input is the latest coordinate record from the database and route information associated with the moving body, including a planned route and a current segment index.

The server computes a current position vector, checks deviation from the planned route using a distance calculation between the recorded position and the nearest point on the route polyline, and derives a travel context including a current segment, remaining distance, and remaining time.

The output is a travel context object containing the current position, route segment identifier, remaining distance, and remaining time, stored in working memory.

### Step 3:

The server evaluates operation-state information and derives control conditions.

The input is operation-state data from a detection device, including speed, acceleration, steering angle, and control mode flags.

The server calculates derived values such as lateral acceleration and a stability score, compares these values against preset thresholds, and determines control conditions that specify whether detailed guidance is allowed, whether only short summaries should be used, and when guidance can be updated.

The output is a control condition object containing flags for timing, level of detail, and expression format parameters, which the server stores in memory and passes to later processing.

### Step 4:

The server searches for candidate stay targets near the current position.

The input is the current position object and travel context object, together with user preference information from a user profile stored in the database.

The server queries an information storage device using a spatial index to retrieve stay targets within a configurable radius, filters the results based on user preference categories and opening hours, and computes a relevance score for each candidate using a weighted sum of distance, popularity, and preference match.

The output is candidate list information, represented as a list of stay target records with identifiers, distances, and scores, sorted by the relevance score and kept in memory and optionally cached in the database.

### Step 5:

The server prepares and transmits a candidate list to the terminal.

The input is the candidate list information and the control condition object.

The server selects a subset of top-ranked candidates according to the level-of-detail setting, trims descriptive text to a length defined by the control conditions, and serializes the selected fields (identifier, name, category, distance, brief description) into a structured message. The server sends this message to the terminal over a network connection.

The output is a candidate list message delivered to the terminal for display.

### Step 6:

The terminal receives and displays the candidate list.

The input is the candidate list message from the server.

The terminal parses the message into an internal collection, constructs list items with text labels and optional thumbnail images, and renders a scrollable list on the display. The terminal may also cache the list in local storage for quick re-display.

The output is a visual list of stay targets on the terminal's display, available for user selection.

### Step 7:

The user selects a stay target on the terminal.

The input is the displayed candidate list.

The user performs a selection operation, such as tapping on a displayed item. The terminal captures the event, identifies the corresponding stay target identifier from the internal collection, and prepares a selection request message including the identifier, user identifier, and current language setting.

The output is a selection request transmitted from the terminal to the server.

### Step 8:

The server acquires detailed attribute information for the selected stay target.

The input is the selection request containing the stay target identifier and user identifier.

The server validates the identifier, retrieves the corresponding full attribute record from the information storage device, and fetches associated data, such as extended descriptions, images, tags, and coordinate data. The server also computes or retrieves travel route information and required time from the current position to the stay target, using a routing algorithm or a route service.

The output is a detailed attribute object representing the selected stay target and a route object including path coordinates and estimated travel time.

### Step 9:

The server collects user profile and session context.

The input is the user identifier, session identifier, and stored session history.

The server reads preference information and state information from a user profile table, extracts recent interaction records and previously generated guidance from a session table, and composes a context object summarizing user tendencies and recent conversation topics.

The output is a context object containing preference information, state information, and conversational context to be used in prompt construction.

### Step 10:

The server constructs document data for prompt generation.

The input is the current position object, travel context object, detailed attribute object, route object, context object, and control condition object.

The server combines these inputs into a multi-field document structure that includes fields for current location, stay target attributes, route summary, user preferences, user state, desired explanation length, and formatting constraints. The server normalizes numeric values (such as distances and times) into human-readable ranges and converts internal identifiers into descriptive labels as needed for text output.

The output is document data that captures all necessary contextual and constraint information in a machine-readable form.

### Step 11:

The server generates a structured prompt sentence for a generative AI model.

The input is the document data and a prompt template library stored in memory.

The server selects a template based on a use case type (for example, initial guidance, follow-up explanation, or itinerary proposal), then maps fields from the document data to placeholder segments in the template. The server concatenates an instruction section, a context description, explicit constraints such as distance limits and time budgets, and a requested output format description into a single prompt sentence.

The output is a structured prompt sentence formatted as plain text and ready for tokenization.

### Step 12:

The server invokes the generative AI model with the structured prompt sentence.

The input is the structured prompt sentence.

The server tokenizes the prompt sentence using a tokenizer associated with the generative AI model, sends the tokens to a model execution engine, and configures model parameters such as maximum output length, temperature, and decoding strategy. The server executes the model on dedicated processing hardware, thereby computing layer-wise activations and attention weights to produce probability distributions for output tokens. The server decodes the tokens into a coherent text that satisfies the prompt constraints.

The output is a generation result containing personalized guidance information and itinerary proposal information in natural language text.

### Step 13:

The server integrates the generation result with basic information.

The input is the generation result and basic information from the information storage device, including verified attributes and route data for the stay target.

The server verifies that entities mentioned in the generation result correspond to valid stay targets, checks that recommended times and distances are within physical constraints, and corrects or annotates inconsistent items. The server merges the validated generation result with the basic information into a detailed guidance object, including structured fields and free-form explanatory text.

The output is detailed guidance information suitable for presentation on the terminal.

### Step 14:

The server applies control conditions and delivers detailed guidance to the terminal.

The input is the detailed guidance information and the control condition object.

The server adjusts the length of text sections, selects which components (such as images and route maps) should be included in the response, and possibly generates summary variants based on the expression format setting. The server constructs a response message including the guidance content and control flags for user interface behavior and transmits this message to the terminal.

The output is a detailed guidance message sent to the terminal that respects current operation-state-based control conditions.

### Step 15:

The terminal displays the detailed guidance information.

The input is the detailed guidance message from the server.

The terminal parses the message, stores the detailed guidance object in local memory, and renders a detailed view including the generated text, verified facts (such as address and opening hours), and a graphical route representation. The terminal uses control flags to decide whether to show a full description or a condensed version, and whether to defer loading images or maps until the user scrolls or taps.

The output is a context-sensitive guidance screen on the terminal that the user can read and interact with.

### Step 16:

The user issues an additional inquiry based on the displayed guidance.

The input is the displayed detailed guidance information.

The user enters a natural language question using a text input field or voice input on the terminal, such as a request for more historical background or alternative routes. The terminal converts a voice input into text if needed, associates the question with the current session identifier and selected stay target, and constructs an inquiry message.

The output is an inquiry message transmitted from the terminal to the server.

### Step 17:

The server generates a dialogue prompt sentence for follow-up guidance.

The input is the inquiry message, the context object from the session, the detailed attribute object, and the travel context object.

The server extracts key terms and intent from the inquiry, selects relevant parts of prior generation results and session history, and composes a dialogue document structure. The server then uses a dialogue template to build a dialogue prompt sentence that includes the user's question, summarized prior context, and any new constraints or updates, such as a reduced available time.

The output is a dialogue prompt sentence ready to be tokenized and input to the generative AI model.

### Step 18:

The server invokes the generative AI model with the dialogue prompt sentence and returns response information.

The input is the dialogue prompt sentence.

The server tokenizes the sentence, runs the generative AI model with decoding settings optimized for concise answers, and obtains a response text. The server verifies the response, filters out content that contradicts system constraints, and constructs a response information object containing the answer and optional suggestions. The server transmits this object to the terminal.

The output is response information that the terminal can present as a conversational reply to the user's inquiry.

### Step 19:

The terminal presents the response information and updates the session state.

The input is the response information object from the server.

The terminal appends the response text to a chat-style display area or a dedicated follow-up section on the detailed guidance screen. The terminal also updates its local representation of the session so that the user can see the history of questions and answers.

The output is an updated user interface reflecting the new system response and an updated local session context on the terminal.

### Step 20:

The server periodically updates guidance based on new position information.

The input is newly acquired position information, the existing travel context object, and the current candidate list information and detailed guidance information.

The server compares new and previous positions, evaluates whether a predetermined condition such as a distance threshold or route deviation is met, and decides whether to refresh the candidate list or detailed guidance. If refresh is required, the server re-runs the candidate search, prompt construction, and generative inference steps selectively, reusing cached generation results where possible.

The output is updated candidate list information and updated detailed guidance information that reflect the new position, delivered to the terminal with minimized redundant computation and communication.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented sightseeing guidance systems that operate in vehicles typically rely on static route plans or pre-authored content associated with fixed points of interest. Such systems generally lack a mechanism to dynamically adapt the guidance content to rapidly changing contextual factors, such as real-time traffic conditions, actual vehicle movement, and a user's interaction history. As a result, these systems often provide redundant or untimely information, consume unnecessary communication and processing resources, and fail to present guidance in a form that matches the temporal constraints imposed by current traffic and driving states.

From the perspective of computer technology, existing systems do not adequately integrate heterogeneous data sources and processing stages—such as position sensing, traffic data retrieval, prompt generation, and generative AI model invocation—into a coordinated control flow optimized for real-time operation. In particular, known systems lack: (i) a processor-level mechanism that programmatically generates and updates a prompt sentence to a generative AI model based on both a presentation history and a travel history, (ii) a state-dependent control logic that adjusts the format and length of generated content according to computed traffic and motion states, and (iii) a structured interaction loop that efficiently incorporates user follow-up requests into subsequent prompt sentences. Without these mechanisms, the computer system tends to generate unnecessary or duplicate content, to invoke generative AI tasks that are not aligned with the current context, and to impose latency and resource overhead that degrade overall system performance.

Accordingly, there is a need for an improved computer-implemented sightseeing guidance system in which a processor coordinates acquisition of position information and traffic information, generation and updating of prompt sentences, and invocation of a generative AI model in a manner that (a) reduces redundant content generation, (b) dynamically tailors the guidance format to real-time driving conditions, and (c) efficiently handles follow-up user requests. Such a system should improve the operation of the underlying computer and network resources by controlling when and how generative AI processing is triggered and by structuring the generated content so that it is better aligned with the timing, bandwidth, and interaction constraints of an in-vehicle environment.

The specific processing by the specific processing unit 290 of the data processing device 12 in Example 2 is realized by the following means.

The present invention provides a server comprising a processor configured to acquire position information of a mobile body, to acquire traffic condition information around the mobile body from an external information processing apparatus, and to generate a prompt sentence including generation conditions for sightseeing guidance content based on the acquired position information and the acquired traffic condition information, to input the prompt sentence to a generative AI model so as to cause the generative AI model to generate sightseeing guidance information in a natural language, to transmit the generated sightseeing guidance information to an information terminal and cause the information terminal to present the sightseeing guidance information visually or audibly, and to update a next prompt sentence to be generated based on a presentation history of the sightseeing guidance information and a travel history of the mobile body so as to suppress generation of duplicate sightseeing guidance information. This enables the computer system to control invocation of the generative AI model and the content generation flow in a context-aware manner, thereby reducing redundant processing, improving the timeliness and relevance of generated guidance, and enhancing the efficiency and technical performance of the sightseeing guidance system.

The term “mobile body” refers to a movable apparatus such as a vehicle or other transport object whose position changes over time and whose position information can be detected by a position sensing device.

The term “position information” refers to data indicating a geographic location of the mobile body, including at least one of latitude, longitude, altitude, or a region identifier, which is obtained from a position sensing device or a location information service.

The term “traffic condition information” refers to data representing a state of traffic in an area around the mobile body, including at least one of speed information of road segments, congestion levels, travel time estimates, or incident information, which is obtained from an external information processing apparatus.

The term “external information processing apparatus” refers to a computing apparatus, separate from the server, that provides traffic condition information or other environmental information via a communication network.

The term “prompt sentence” refers to a character string including one or more instructions, constraints, or conditions to be input to a generative AI model, the character string being generated based on at least position information and traffic condition information.

The term “generation conditions for sightseeing guidance content” refers to parameters, constraints, or contextual descriptions included in the prompt sentence that specify at least one of a target place, a guidance format, a detail level, a time constraint, or a user preference for sightseeing guidance.

The term “generative AI model” refers to a machine-learned model configured to generate natural language text or other content in response to an input prompt sentence, using probabilistic generation based on parameters obtained through training on data.

The term “sightseeing guidance information” refers to natural language content generated by the generative AI model that describes at least one of points of interest, historical or cultural background, recommended activities, or facilities in an area related to the position information.

The term “information terminal” refers to an electronic device, such as a user-operated communication or display device, that is configured to receive sightseeing guidance information from the server and to present the received information visually and/or audibly.

The term “presentation history” refers to data recording past presentations of sightseeing guidance information to a user, including at least information indicating which guidance content was presented, when it was presented, and optionally how it was interacted with.

The term “travel history” refers to data representing a past movement trajectory of the mobile body, including at least a time series of position information and optionally associated traffic conditions.

The term “congestion state” refers to a state of traffic characterized by reduced traveling speed or increased travel time relative to a normal state, the state being determined based on traffic condition information.

The term “running state” refers to a state in which the mobile body is traveling at or above a predetermined threshold speed, the state being determined based on at least one of traffic condition information and sensor information of the mobile body.

The term “stop state” refers to a state in which the mobile body is substantially not moving, as determined by a speed below a predetermined threshold for at least a predetermined time interval.

The term “sightseeing guidance format” refers to a style or structure of sightseeing guidance information, including at least one of a short-stay format, a long-stay format, and an in-vehicle-viewing format, each format differing in at least one of detail level, time span, or content focus.

The term “short-stay format” refers to a sightseeing guidance format adapted to a relatively short available time, in which the sightseeing guidance information is focused on brief activities or highlights that can be experienced within a limited period.

The term “long-stay format” refers to a sightseeing guidance format adapted to a relatively long available time, in which the sightseeing guidance information includes more detailed descriptions, extended routes, or multiple activities.

The term “in-vehicle-viewing format” refers to a sightseeing guidance format that is intended to be consumed while the user remains inside the mobile body, and that emphasizes content suitable for appreciation without disembarking, such as distant viewing points or background stories.

The term “user interface information” refers to data defining elements of a user interface on the information terminal, such as buttons, input fields, or selectable items, which enable a user to provide additional input requesting supplemental or detailed sightseeing guidance information.

The term “additional input” refers to information transmitted from the information terminal to the server representing a user's request for supplemental explanation, detailed information, or a change in focus of sightseeing guidance, the information being obtained through the user interface.

The term “follow-up sightseeing guidance information” refers to sightseeing guidance information that is generated by the generative AI model based on a reconstructed prompt sentence that incorporates additional input representing a user's follow-up request.

In one embodiment, a server cooperates with a terminal and a mobile body to realize the claimed system. The server executes a computer program on hardware resources such as a general-purpose computing platform including at least one processor, a main memory, a non-volatile storage device, a network interface, and optionally one or more accelerator devices. The server includes executable modules for communication, data acquisition, state estimation, prompt sentence generation, generative AI model interaction, response post-processing, and history management. The terminal includes at least one processor, a display unit, an audio output unit, an input unit, and a communication module. The mobile body includes a position sensing device such as a global navigation satellite system receiver, and may further include various sensors such as speed sensors and acceleration sensors.

The server uses an operating system, for example, a general-purpose operating system, and middleware such as a web server, application server, database management system, and in some implementations a container runtime. The server stores a generative AI model in a model storage area and executes inference of the generative AI model using a dedicated accelerator device such as a graphics processing unit or a tensor processing unit, or using vectorized instructions of a central processing unit.

The server acquires position information of the mobile body by receiving, through the network interface, packets that include position data generated by the position sensing device. The server parses the packets, decodes the position data, and stores the data in a structured format in the main memory, for example, as records containing latitude, longitude, and timestamp fields. The server optionally writes such records to a geospatial database, for example, a relational database management system with a spatial extension, where the position information is indexed using geospatial indexes such as R-trees.

The server acquires traffic condition information around the mobile body by transmitting, through the network interface, a request message to an external information processing apparatus that provides traffic data. The request message includes at least the current position information of the mobile body and an area specification. The server receives a response message including, for example, average speed on each road segment, congestion levels, estimated travel times, and incident identifiers. The server parses the response message, converts the response data into an internal representation, and associates each piece of traffic condition information with the corresponding position information in memory.

The server determines a traffic state such as a congestion state, a running state, or a stop state based on the traffic condition information and optionally on sensor information received from the mobile body. The server, for example, compares a current speed value with a free-flow reference speed and determines a congestion state when the ratio falls below a predetermined threshold. The server determines a stop state when the speed value remains below a second threshold for longer than a predetermined time interval. The server stores the current traffic state together with a timestamp and the corresponding position information in a traffic state history data structure.

The server manages a presentation history and a travel history. The server stores, as the presentation history, identifiers of sightseeing guidance information that has been transmitted to the terminal, their associated position information, and timestamps in a structured table. The server stores, as the travel history, a sequence of records containing position information, traffic state, and associated metadata. The server uses an index structure for these histories to enable fast lookup of previously presented content and visited areas.

The server generates a prompt sentence for a generative AI model according to the current context. The server first identifies one or more candidate sightseeing regions or points of interest near the current position, for example, by executing a spatial query on the geospatial database using the latitude and longitude as input. The server then determines whether the candidate regions or points of interest have already been associated with previously presented guidance by consulting the presentation history. When the candidate is new or has not been presented within a predetermined distance or time window, the server constructs a prompt sentence.

The server constructs the prompt sentence using a template mechanism. The server stores templates as character strings with variable slots, such as a slot for a place name, a slot for a traffic state description, and a slot for a time constraint. The server fills these slots using current context parameters computed by the server, such as an estimated available time derived from the traffic state and a predicted delay. For example, the server generates a prompt sentence of the form:
“The vehicle is currently near a major temple in an urban area. Traffic is moderate, and the user is interested in history and local food. Please generate a sightseeing guide that explains the history and cultural significance of the temple, highlights key spots such as the main gate and the shopping street, and recommends nearby restaurants serving traditional dishes within a 15-minute walk.”

In another example, when the server determines a heavy congestion state on a major intersection, the server generates a prompt sentence of the form:
“The vehicle is stuck in heavy traffic near a busy crossing in a metropolitan area. Please describe the main sightseeing spots around the crossing, including a central square, a famous statue, and nearby shopping areas. Provide interesting stories, typical visiting times, and suggestions for short activities that can be done if the user has only 30-60 minutes.”

In yet another example, when the server detects that the vehicle is traveling along a coastline, the server generates a prompt sentence of the form:
“The vehicle is driving along the coast near an island area in the afternoon. The weather is clear. Please generate a sightseeing guide emphasizing scenic viewpoints, a shrine on the island, and cafés with ocean views suitable for a 1- to 2 -hour stop.”

The server uses the generative AI model to generate sightseeing guidance information based on the prompt sentence. In one embodiment, the generative AI model is implemented as a transformer-based neural network having multiple encoder-decoder layers and attention mechanisms. The server stores model parameters such as weight matrices and bias vectors in a model parameter storage. During inference, the server converts the prompt sentence into a sequence of tokens according to a pre-defined vocabulary, generates embedding vectors for the tokens, and applies multi-head self-attention and feedforward layers to compute context-aware representations. The server then applies a decoding procedure that iteratively computes probability distributions over the vocabulary for the next token using a softmax function on the output layer and samples or selects tokens according to a decoding strategy such as greedy decoding, beam search, or nucleus sampling. The server stops decoding when an end-of-sequence token is generated or when a maximum token length is reached.

The server uses a set of control parameters, such as temperature, maximum number of tokens, and a repetition penalty factor, to regulate the generative AI model. The server may adjust these control parameters according to the determined sightseeing guidance format. For example, when the server designates a short-stay format, the server sets the maximum number of tokens to a relatively small value and enforces a higher repetition penalty to produce concise and non-redundant content. When the server designates a long-stay format, the server allows a larger maximum number of tokens and relaxes the repetition penalty to produce more detailed descriptions.

The server may train the generative AI model in advance using a training dataset including text data of sightseeing descriptions, historical explanations, and route recommendations. The server or an external training system minimizes a loss function, such as cross-entropy loss between predicted token distributions and ground-truth tokens, and updates the model parameters using an optimization algorithm such as stochastic gradient descent or an adaptive method. The server may apply data augmentation techniques, such as paraphrasing or context variation, to improve robustness and generalization. By tailoring the training data and loss function to sightseeing content, the generative AI model learns domain-specific features that support more accurate and relevant guidance.

The server performs post-processing on the generated sightseeing guidance information. The server segments the generated text into sections, such as an overview section, a highlight section, a recommended route section, and a food and drink section. The server may use pattern matching or a lightweight classifier to detect headings or enumerate points. The server structures the results into a defined data structure, for example, a record comprising a title field, a list of section records, and a list of point-of-interest records. The server may also filter or shorten the text according to resource constraints, such as limited display area or predicted user attention span derived from the traffic state.

The server transmits the sightseeing guidance information to the terminal. The server converts the structured data into a message format suitable for network transmission and sends the message through the network interface to the terminal. The server may apply compression and encryption to reduce bandwidth and increase security. The server records in the presentation history an entry including an identifier of the generated guidance, the associated position, the timestamp, and the sightseeing guidance format used.

The terminal receives the sightseeing guidance information from the server. The terminal parses the received message and stores the structured data in a local memory. The terminal generates a graphical user interface layout based on the structured data. The terminal displays a notification or banner to inform the user that new sightseeing guidance is available and displays a detailed view with headings, paragraphs, and highlighted points when the user operates an input element. The terminal optionally uses a text-to-speech engine to convert the text into audio signals and outputs the audio through the audio output unit. The terminal may synchronize highlighting of text segments with audio playback to aid user comprehension.

The terminal provides user interface information for additional input. The terminal displays interactive elements such as buttons labeled with actions like “More details,” “Show nearby restaurants,” or “Explain history in depth.” When the user selects one of these elements, the terminal generates additional input information indicating the requested type of follow-up guidance, attaches current context such as the active point-of-interest identifier, and transmits this additional input to the server.

The server receives the additional input from the terminal and reconstructs a new prompt sentence that incorporates the user's request while referencing the previously generated content and context. For example, the server reconstructs a prompt sentence of the form:
“The user is currently receiving sightseeing guidance about a temple in an urban area and has requested traditional restaurants within a 10-minute walk. Please list several recommended restaurants, describe their typical dishes, price range, and any special features, in concise bullet points.”

The server uses this reconstructed prompt sentence as input to the generative AI model and generates follow-up sightseeing guidance information. The server then performs the same transmission and presentation steps. By controlling reconstruction of prompt sentences using structured context and user input, the server implements a non-conventional interaction loop that manages generative AI processing flows more efficiently than a simple stateless question-response pattern.

The server continuously updates a next prompt sentence to be generated based on the presentation history and the travel history. When the mobile body moves into an area where similar guidance has already been presented, the server checks the history and refrains from generating redundant content. Instead, the server may update the prompt sentence to request incremental or alternative viewpoints, such as seasonal differences or advanced topics, thereby reducing communication traffic and computation load. This history-aware prompt management improves computational efficiency and reduces unnecessary invocations of the generative AI model.

The described configuration improves computer technology in several ways. First, by tightly integrating position information, traffic condition information, and history data into the prompt generation process, the server reduces the frequency and size of generative AI model invocations, thereby decreasing processor load, memory usage, and network bandwidth consumption. Second, by selecting sightseeing guidance formats according to running, congestion, and stop states, the server aligns the length and complexity of the generated content with the available user attention window, which reduces wasted processing for content that cannot be consumed. Third, by structuring histories and prompts in specific data structures and using non-conventional rules to update prompts, the server implements an adaptive generative AI orchestration algorithm that is not a mere automation of a human tour guide's behavior but a technical control scheme that optimizes system resource utilization and latency.

Further, the system departs from generic “data acquisition-analysis-display” flows by defining concrete data structures (position records, traffic state records, presentation entries, travel trajectory records), by specifying deterministic rules and thresholds for state classification and format selection, and by structuring the prompt sentence as a machine-oriented control artifact that encapsulates generation conditions. This architecture ensures that each component, from sensor-level data to generative AI model interface, contributes to a unified control loop that can be systematically analyzed and optimized.

In another embodiment, the server may use a different type of generative AI model, such as an encoder-only or decoder-only transformer, or a recurrent neural network with attention. The server may further incorporate additional features into the model input, such as encoded traffic state vectors, time-of-day indicators, and user preference embeddings. The server may pre-pend a system instruction segment to the prompt sentence that encodes these features in a structured textual format, thereby influencing the internal attention patterns of the model and improving relevance and consistency of the output. In another variation, the server may maintain multiple generative AI models specialized for different content types (e.g., history, food, logistics) and select or ensemble models according to the sightseeing guidance format selected.

In yet another embodiment, the server may reside partly at an edge node located close to the mobile body to reduce latency and partly at a remote data center. The edge server may handle high-frequency tasks such as state estimation and prompt sentence construction, while the remote server performs heavy generative AI inference. This partitioning further optimizes communication load and response time.

By these configurations, the server, the terminal, and the mobile body cooperatively implement a system that performs not only abstract information processing but also concrete control over when and how computationally intensive generative AI operations are invoked, how content is structured and filtered, and how resources are allocated according to real-world vehicle and traffic states. As a result, the system achieves technical effects such as reduction of redundant processing, improved responsiveness, and decreased network bandwidth usage, thereby improving the overall performance of the computer-implemented sightseeing guidance system.

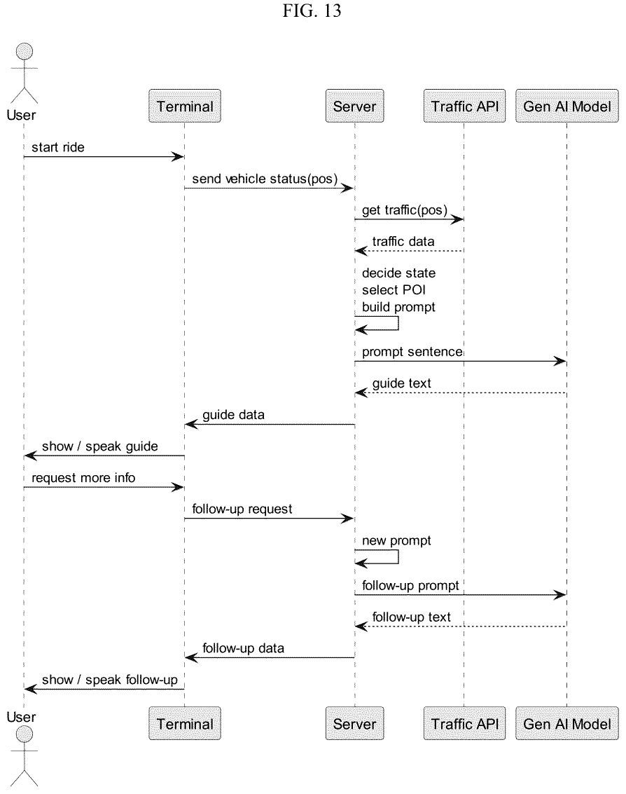

The following describes the processing flow using FIG. 13.

### Step 1:

The server acquires raw position information of the mobile body.

The server receives, as input, communication packets from an on-board communication unit that include raw position data such as latitude, longitude, and timestamp produced by a position sensing device. The server parses the packets, extracts numerical fields, and converts them into a normalized internal record, for example a structure with fields (latitude, longitude, timestamp, speed). The server outputs the normalized position record and stores it in working memory and optionally in a geospatial database for later queries.

### Step 2:

The server acquires traffic condition information around the mobile body.

The server receives, as input, the current normalized position record from Step 1. The server sends a request message including the position and a radius parameter to an external information processing apparatus via a network interface. The server receives a response message containing traffic condition information such as average speed per road segment, congestion level codes, and estimated travel times. The server parses the response, maps raw values onto an internal format (for example, normalized congestion scores), and outputs a traffic condition record associated with the current position.

### Step 3:

The server determines a traffic state of the mobile body.

The server receives, as input, the traffic condition record from Step 2 and optionally vehicle speed data from sensors. The server compares speed values and congestion scores against predefined thresholds, and the server executes conditional logic to classify the current situation into one of a congestion state, a running state, or a stop state. The server outputs a traffic state label together with the associated position and time, and the server stores this label in a traffic state history data structure.

### Step 4:

The server maintains and updates a travel history.

The server receives, as input, the normalized position record from Step 1 and the traffic state label from Step 3. The server appends a new entry to a travel history structure that includes fields such as position, traffic state, and timestamp. The server may compress or aggregate older entries by down-sampling or segmenting trajectories. The server outputs an updated travel history that can be queried by downstream logic.

### Step 5:

The server maintains and consults a presentation history.

The server receives, as input, the current position record and an internal identifier of the active area or point of interest calculated from previous processing. The server queries a presentation history table to determine whether sightseeing guidance for this area or a nearby area has already been presented within a specified distance or time window. The server outputs a presentation status indicator that represents whether the area is new, recently presented, or previously presented long ago, and the server updates the presentation history when new guidance will be generated.

### Step 6:

The server selects candidate sightseeing regions or points of interest.

The server receives, as input, the current position record and the travel history. The server executes a spatial query on a geospatial database to find records of sightseeing regions or points of interest within a predetermined radius. The server computes distances and, optionally, direction angles between the current position and each candidate. The server applies selection rules, such as preferring the closest or most significant point of interest, and outputs one or more selected candidates with their attributes (name, category, coordinates).

### Step 7:

The server decides whether to trigger generation of new sightseeing guidance.

The server receives, as input, the selected candidate information from Step 6, the traffic state label from Step 3, and the presentation status from Step 5. The server applies decision rules: for example, the server triggers new generation when a candidate has not been presented recently and the mobile body is within a distance threshold, or when a congestion state is detected and no special congestion-related guidance has been provided. The server outputs a generation trigger flag and, if the flag is set, a context object including position, traffic state, candidate information, and presentation history details.

### Step 8:

The server determines a sightseeing guidance format.

The server receives, as input, the traffic state label and the context object from Step 7. The server executes conditional logic to select at least one sightseeing guidance format among a short-stay format, a long-stay format, and an in-vehicle-viewing format. For example, when the traffic state is congestion, the server may choose an in-vehicle-viewing format; when the mobile body is stopped for a long duration, the server may choose a long-stay format. The server outputs a guidance format indicator that is used to control subsequent generation conditions.

### Step 9:

The server generates a context-aware prompt sentence.

The server receives, as input, the context object from Step 7 and the guidance format indicator from Step 8. The server retrieves a template corresponding to the selected guidance format from a template storage. The server fills template slots with data fields such as a place name, traffic state description, estimated available time, and user preference profile. The server performs string concatenation and parameter substitution to produce a coherent natural language prompt sentence. The server outputs the constructed prompt sentence for use by the generative AI model.

### Step 10:

The server invokes a generative AI model to generate sightseeing guidance information.

The server receives, as input, the prompt sentence from Step 9. The server tokenizes the prompt sentence according to the vocabulary of the generative AI model and transfers the token sequence and control parameters (for example, maximum tokens, temperature) to an inference engine running on a processor or accelerator. The server causes the generative AI model to perform matrix multiplications, attention computations, and nonlinear transformations to compute probability distributions over next tokens and to produce a sequence of output tokens. The server decodes these tokens back into text to obtain sightseeing guidance information and outputs the generated text as a sightseeing guidance document.

### Step 11:

The server post-processes and structures the generated sightseeing guidance information.

The server receives, as input, the sightseeing guidance document from Step 10 and the guidance format indicator from Step 8. The server parses the text to identify logical segments such as introductions, highlight lists, and recommendations. The server may apply rules or lightweight models to detect headings or bullet-like structures. The server organizes the content into a structured representation with fields such as title, summary, sections, and list entries. The server outputs this structured sightseeing guidance object for delivery to the terminal and logs an entry in the presentation history.

### Step 12:

The server transmits sightseeing guidance information to the terminal.

The server receives, as input, the structured sightseeing guidance object from Step 11 and an identifier of the target terminal associated with the mobile body. The server serializes the structured object into a transport message and sends the message through the network interface using a communication protocol. The server may apply compression and encryption prior to transmission. The server outputs a transmission status and, when successful, stores a record linking the guidance object to the corresponding position and time.

### Step 13:

The terminal receives and parses the sightseeing guidance information.

The terminal receives, as input, the transport message transmitted in Step 12. The terminal decodes and, if necessary, decompresses the message, and parses the serialized data to reconstruct the structured sightseeing guidance object. The terminal stores this object in local memory, indexing it by an internal identifier and timestamp. The terminal outputs the reconstructed object to its presentation module for display or audio output.

### Step 14:

The terminal presents the sightseeing guidance information to the user.

The terminal receives, as input, the structured sightseeing guidance object from Step 13. The terminal generates a graphical layout based on the title, sections, and lists, and renders them on a display unit. The terminal may, according to settings, invoke a text-to-speech engine to convert the text segments into audio waveforms and output them through an audio device. The terminal outputs user-visible and/or audible sightseeing guidance and may also store a local presentation timestamp.

### Step 15:

The terminal collects additional input from the user.

The terminal receives, as input, the current display state showing the sightseeing guidance and user actions such as touch events or button selections. The terminal interprets these actions as additional input specifying a type of follow-up request, for example, a request for more detailed historical information or nearby restaurants. The terminal packages the additional input together with context identifiers (such as the current point of interest identifier) into a message. The terminal outputs this additional input message and sends it to the server.

### Step 16:

The server processes additional input and reconstructs a follow-up prompt sentence.

The server receives, as input, the additional input message from Step 15 and the previously stored context for the currently active guidance. The server interprets the type of requested information and combines it with the context to form a new set of generation conditions. The server selects an appropriate template for follow-up content and inserts variables reflecting the user's request, time constraints, and current location. The server generates a new prompt sentence that explicitly requests follow-up sightseeing guidance, and outputs this follow-up prompt sentence for use by the generative AI model.

### Step 17:

The server generates and delivers follow-up sightseeing guidance information.

The server receives, as input, the follow-up prompt sentence from Step 16. The server repeats the invocation of the generative AI model and the post-processing steps similar to Steps 10 and 11, but using the follow-up prompt sentence and possibly updated control parameters tailored for concise follow-up content. The server outputs a follow-up sightseeing guidance object and transmits it to the terminal using the same communication mechanism as in Step 12, thereby updating the user with additional, context-specific information.

### Step 18:

The server updates histories to suppress duplicate guidance and optimize future prompts.

The server receives, as input, the final version of the sightseeing guidance object delivered to the terminal (including follow-up content, if any) and the current travel history entry. The server writes a new record into the presentation history associating the guidance object, the relevant point of interest, the guidance format, and the time and place of presentation. The server may also update summary statistics, such as the number of times a place has been presented. The server outputs updated presentation and travel histories, which are used in subsequent executions of Steps 5 through 9 to avoid redundant guidance and to produce more efficient, context-aware prompt sentences.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented sightseeing guidance systems generally retrieve static content from databases based solely on a user's location and possibly a manually selected category. In such systems, a processor typically issues simple queries to a content repository and presents pre-authored text or templates to a user terminal. These systems exhibit several technical limitations.

First, the processor is not designed to construct rich, context-dependent instructions for a generative AI model. Instead, content is generated or selected using rigid rules that do not adapt to rapidly changing environmental conditions such as traffic congestion, current traveling state of a vehicle, or fine-grained emotional state of the user. As a result, the computing resources (for example, a generative AI model and network bandwidth) are not effectively utilized, since the model is either not used at all or is supplied with under-specified prompts that yield generic, low-relevance output.

Second, conventional systems do not integrate heterogeneous sensor data streams (e.g., positioning data, vehicle state data, traffic condition data, image data, and audio data) into a unified prompt construction pipeline. The processor typically treats each data source independently and does not transform these multimodal signals into a structured, machine-readable context for the generative AI model. This leads to inefficiencies in the information processing pipeline, such as redundant database accesses, unnecessary user interactions, and increased latency in generating relevant guidance.

Third, conventional systems are not configured to dynamically modulate the content and presentation order of generated guidance according to real-time emotion recognition. Even where basic sentiment analysis is present, the emotion signal is usually applied as a superficial filter on pre-existing text, rather than being incorporated at the prompt-construction stage. Consequently, the generative AI model cannot exploit the user's emotional state to condition the generation process, and the overall system fails to optimize the computational flow from sensor input to natural-language output.

Fourth, existing architectures do not provide a systematic mechanism for using structured data—such as historical background information, cultural background information, recommended visiting time zones and seasons, and caution information—as part of the input to a generative AI model. Instead, such data is often flattened or partially omitted before being presented to the user, which degrades the quality and consistency of generated text and increases the need for post-processing on the terminal side.

Accordingly, there is a need for an improved computer-implemented system and processing architecture in which a processor: (i) acquires and fuses location-related information, vehicle traveling state information, traffic situation information, and emotion recognition results; (ii) selects and ranks sightseeing targets based on this fused context; (iii) generates context-rich prompt sentences that embed structured sightseeing data and emotional state; and (iv) causes a generative AI model to output natural-language explanation information that is dynamically adjusted in content and presentation order. Such an improved system can reduce computational waste, increase the relevance and timeliness of generated guidance, and enhance the efficiency of the end-to-end processing pipeline from sensor acquisition to information presentation.

The specific processing by the specific processing unit 290 of the data processing device 12 in Application Example 2 is realized by the following means.

The present invention provides a server comprising a processor configured to control a mobile body for transportation to perform automatic traveling control, cooperate with a shared-use management service to manage reservation information and usage status, acquire current position information from a positioning apparatus and, based on the acquired current position information, acquire candidate information of surrounding sightseeing targets as location-related information, select sightseeing targets by ranking the candidate information based on the candidate information and an emotional state of a user, generate text including at least the selected candidate information and the emotional state of the user, construct a prompt sentence for input to a generative information processing model using the generated text, cause the generative information processing model to generate, in a natural language, explanation information relating to the sightseeing targets by inputting the prompt sentence to the generative information processing model, identify the emotional state of the user based on at least one of image information and audio information, adjust content or presentation order of the explanation information generated by the generative information processing model in accordance with the identified emotional state, and present the explanation information to the user through at least one of a display apparatus and an audio output apparatus. This enables the server to transform heterogeneous sensor and state data into structured, context-rich prompt sentences for the generative information processing model, thereby improving the technical operation of the computer system by dynamically generating and delivering high-relevance sightseeing guidance with reduced processing redundancy, improved use of computational resources, and enhanced responsiveness to real-time vehicle conditions and user emotions.

The term “mobile body for transportation” refers to a movable apparatus configured to transport one or more persons or goods, including but not limited to a vehicle, which is controllable by an automatic traveling control function.

The term “automatic traveling control” refers to a control operation in which driving of the mobile body for transportation is performed autonomously by a computer system on the basis of sensor information and control algorithms, without continuous manual operation by a human driver.

The term “shared-use management service” refers to an information processing service configured to manage shared use of the mobile body for transportation by a plurality of users, including at least reservation management and usage status management through a communication network.

The term “reservation information” refers to data indicating at least a planned use of the mobile body for transportation by a user, including one or more of a user identifier, a time period, a departure location, and a destination location.

The term “usage status” refers to data indicating a current or past state of use of the mobile body for transportation, including one or more of a current user, a current route, a traveling state, and a remaining time or distance.

The term “positioning apparatus” refers to a hardware and software combination configured to detect a geographical position, including but not limited to a satellite-based positioning system receiver, and to output position information such as latitude and longitude.

The term “current position information” refers to data representing a present geographical location of the mobile body for transportation or a terminal, including coordinate values and optionally time information.

The term “location-related information” refers to information associated with a geographical location, including at least candidate information of surrounding sightseeing targets, and optionally additional environmental information such as traffic conditions.

The term “sightseeing target” refers to a place, facility, object, or event that is suitable for visit, viewing, or experience by a user for sightseeing or leisure purposes, including but not limited to landmarks, cultural facilities, commercial areas, and natural sites.

The term “candidate information of surrounding sightseeing targets” refers to information items associated with one or more sightseeing targets located within a predetermined range from the current position, including at least an identifier, a name, a category, and optionally evaluation information or descriptive information.

The term “candidate selection function” refers to a processing function executed by the processor to rank and select one or more sightseeing targets from among a plurality of candidates based on one or more criteria, including at least location-related information and an emotional state of the user.

The term “text” refers to a sequence of character data representing natural language or structured language, which is generated or processed by the processor and used as part of a prompt sentence or explanation information.

The term “prompt sentence” refers to an input text supplied to a generative information processing model, the input text including instructions, constraints, and contextual information that condition the output generated by the generative information processing model.

The term “generative information processing model” refers to a machine-learned model configured to generate new information, including at least natural-language text, in response to an input prompt sentence, based on parameters obtained through training on example data.

The term “generation instruction function” refers to a processing function executed by the processor to cause the generative information processing model to perform generation of explanation information by supplying the prompt sentence and controlling one or more generation parameters.

The term “image information” refers to digital data representing at least one still image or moving image captured by an imaging device, including pixel values or compressed image data.

The term “audio information” refers to digital data representing sound captured by a sound collection device, including sampled waveform data or compressed audio data.

The term “emotional state of a user” refers to a state representing a psychological condition of the user, such as excitement, relaxation, boredom, or sadness, identified based on analysis of at least one of image information and audio information.

The term “emotion recognition function” refers to a processing function executed by the processor or by an external emotion recognition service to analyze image information and/or audio information and to output data indicating the emotional state of the user.

The term “guidance adjustment function” refers to a processing function executed by the processor to modify at least one of content, level of detail, emphasis, or presentation order of explanation information, based on the emotional state of the user or other contextual information.

The term “explanation information” refers to natural-language information describing one or more sightseeing targets, including at least an outline, characteristics, and recommended ways of experiencing the sightseeing targets.

The term “presentation order” refers to a sequence in which pieces of explanation information, or portions thereof, are output or displayed to the user.

The term “display apparatus” refers to an output device configured to visually present information to the user, including but not limited to a screen, a head-mounted display, or a smart glasses display.

The term “audio output apparatus” refers to an output device configured to audibly present information to the user, including but not limited to a loudspeaker or an earphone.

The term “information presentation function” refers to a processing function executed by the processor or a terminal to control output of explanation information to the user through the display apparatus and/or the audio output apparatus.

The term “state detection apparatus” refers to a sensing apparatus configured to detect a traveling state of the mobile body for transportation, including at least one sensor such as a speed sensor, acceleration sensor, steering sensor, or positional sensor, and to output traveling state information.

The term “traveling state information” refers to data indicating at least one of speed, acceleration, steering angle, stop state, or route state of the mobile body for transportation.

The term “traffic situation information” refers to data representing a condition of traffic in an area around the current position, including at least congestion, flow speed, and occurrence of restrictions or incidents.

The term “congestion state” refers to a state in which the mobile body for transportation is traveling at a speed below a predetermined threshold or is frequently stopped due to traffic conditions, as determined from traveling state information and traffic situation information.

The term “waiting time” refers to a period in which the mobile body for transportation is in the congestion state or stopped, such that the user can spend time consuming explanation information without significantly affecting travel operation.

The term “structured data” refers to data organized according to a predefined schema, including fields such as an identifier, historical background information, cultural background information, recommended visiting time zone information, recommended visiting season information, and caution information for each sightseeing target.

The term “historical background information” refers to information related to a history of a sightseeing target, including at least information about an origin, important events, or development over time.

The term “cultural background information” refers to information related to cultural aspects of a sightseeing target, including at least customs, artistic significance, religious significance, or local traditions associated with the sightseeing target.

The term “recommended visiting time zone information” refers to information indicating a recommended time period within a day for visiting a sightseeing target, such as morning, afternoon, evening, or night.

The term “recommended visiting season information” refers to information indicating a recommended time period within a year for visiting a sightseeing target, such as a specific month or season.

The term “caution information” refers to information indicating cautions, restrictions, or recommendations related to visiting a sightseeing target, including at least safety notices, dress codes, reservation requirements, or behavior guidelines.

In one embodiment, a server cooperates with a terminal and a mobile body for transportation to implement the claimed system. The server includes at least one processor, a memory storing program instructions and data structures, and a network interface. The terminal includes at least one processor, a display apparatus and/or a head-mounted display, an audio output apparatus, a camera, a microphone, a positioning apparatus such as a satellite-based positioning receiver, and a network interface. The mobile body for transportation includes a vehicle control unit configured to receive control commands from the server, a drive system, and sensors such as speed sensors, acceleration sensors, steering angle sensors, and additional environment sensors.

The server executes operating system software and middleware configured to implement web communication, database access, and machine learning inference. The server may execute, for example, a general-purpose operating system, an application server framework, and a machine learning framework such as a neural-network inference engine. The generative AI model is executed either on the same server or on a cooperating computation node connected via a network. The terminal executes a client application that communicates with the server via a communication network such as a wireless network, and that controls acquisition of user context, including position and emotional state.

The server uses a database management system to store structured data representing sightseeing targets. In one embodiment, the server uses a relational database system and defines tables that store fields such as a target identifier, a target name, category information, historical background information, cultural background information, recommended visiting time zone information, recommended visiting season information, and caution information. The server additionally stores machine-readable tags describing attributes of each sightseeing target, such as “exciting,” “relaxing,” “quiet,” or “lively,” which are used later in the ranking and selection of sightseeing targets.

The terminal acquires current position information by invoking positioning APIs of the positioning apparatus. The terminal periodically measures satellite signals and calculates latitude, longitude, and optional altitude. The terminal packages the current position information together with an identifier of the terminal and a timestamp and transmits this information to the server by means of a network protocol. The terminal also acquires image information and audio information that represent the face and voice of the user by activating the camera and microphone. The terminal either sends these raw data streams to the server or executes an on-device preprocessing algorithm that converts the raw data into compact feature vectors, such as facial landmark coordinates or mel-frequency cepstral coefficients (MFCCs).

The server receives the current position information and the user context from the terminal and stores them in memory. The server accesses an external map service by transmitting the position information to a map API interface in order to obtain location-related information, including candidate information of surrounding sightseeing targets. The server receives candidate information in a structured format, for example, with fields such as name, approximate location, and category. The server then queries its local database management system with the identifiers or names of these candidates to retrieve detailed structured data including historical background, cultural background, recommended time zones, recommended seasons, and cautions.

The server uses an emotion recognition function to determine the emotional state of the user based on the image information and audio information. In one embodiment, the server implements a convolutional neural network (CNN) that receives normalized facial images as input, extracts convolutional feature maps, and performs classification into one of multiple discrete emotional states, such as excitement, relaxation, boredom, and sadness. The server also implements a recurrent or transformer-based network for audio emotion recognition that receives time-series features derived from the audio waveform. The server fuses the outputs of the visual and audio classifiers, for example by weighted averaging of probability vectors, to obtain a final emotional state label and confidence. The server stores the emotional state as structured data linked to the user session.

The generative AI model is implemented as a sequence-to-sequence neural network, for example a transformer-based architecture with an encoder and a decoder. The server trains or uses a pre-trained generative AI model with parameters adjusted via gradient-based optimization. During training, the server uses a corpus of travel-related text data and associated structured meta-data. The server defines a loss function such as a token-level cross-entropy between predicted tokens and reference tokens, and updates the model's weight parameters by backpropagation and an optimization algorithm such as stochastic gradient descent with adaptive learning rate. The server may perform data augmentation by reordering sections, masking tokens, or adding paraphrases to increase robustness to variation in prompt sentences.

The server defines a specific internal data structure for prompt construction. The server represents each candidate sightseeing target as an object containing fields for name, distance from current position, category, tags representing “exciting,” “relaxing,” and other attributes, historical background, cultural background, recommended times and seasons, and cautions. The server passes this list of candidate targets to a ranking component. The ranking component implements a non-trivial scoring algorithm that combines relevance to the user's current position, predicted travel time estimated from a routing algorithm, predicted congestion risk, and compatibility with the user's emotional state based on the tags assigned to each sightseeing target.

The server computes a score for each sightseeing target by combining these factors in a weighted sum that is not constant but is adaptively adjusted according to use statistics and feedback. For example, the server increases the weight applied to the “relaxing” tag when the emotional state corresponds to sadness or fatigue, and increases the weight applied to the “exciting” tag when the emotional state corresponds to excitement. The server then sorts the candidate sightseeing targets by the computed score and selects a subset of top-ranked targets. This ranking and selection algorithm provides a technical effect because it reduces the number of targets that must be processed by downstream modules and reduces the length of prompt sentences, thereby decreasing computational load and communication bandwidth.

The server constructs a prompt sentence for the generative AI model using a deterministic composition algorithm. The server does not merely concatenate arbitrary text but organizes the structured data into a specific template that has been found to improve the quality and determinism of the model's output. For example, the server composes the prompt with labeled sections such as “Current location: [text],” “User emotion: [text],” “Nearby spots: [enumerated list],” and “Instruction: [specific task].” This internal prompt structure reduces ambiguity and variance in model output by providing explicit labels and boundaries for each kind of information.

The server may generate a prompt sentence such as:
“Current location: near Tokyo Tower in Tokyo, Japan.
User emotion: excited.
Nearby spots:
1) Tokyo Tower—landmark, built in 1958, great night view; tags: exciting, panorama.
2) Zojo-ji Temple—historical temple, quiet atmosphere, important in the Edo period; tags: cultural, relaxing.
You are a travel guide. Using this information, generate a friendly explanation of these spots, focusing on what an excited tourist would enjoy. Recommend an order to visit and include brief reasons.”

In another example, when the server detects a congestion state based on traveling state information and traffic situation information, the server constructs a different prompt sentence such as:
“The user is in a traffic jam near Kyoto Station.
User emotion: bored.
Nearby spots: list of cultural sites and historical spots within a 3 km radius.
Provide interesting facts and stories about these nearby historical sites that can keep an adult traveler entertained for about 5 minutes of reading while waiting in traffic.”

The server then transmits the prompt sentence to the generative AI model via a model interface. Internally, the server converts the prompt sentence into a token sequence using a tokenizer. The generative AI model processes the token sequence through its encoder stack, applying multiple self-attention layers to compute context-aware representations of all tokens. The decoder generates output tokens one by one, conditioned on both the encoder representations and previously generated tokens. The server may control generation parameters such as temperature, top-k or nucleus sampling to balance determinism and variety. The server receives the generated token sequence from the model interface and decodes it back into a text string representing explanation information.

The server applies a post-processing module that parses the generated explanation information and divides it into segments corresponding to each sightseeing target and to various content types, such as historical background, recommended visiting times, and cautions. The server maps each segment back to the original structured data to verify that the generative text does not introduce contradictions with the database contents. When inconsistency is detected, the server may adjust or regenerate portions of the text by modifying the prompt sentence, for example by adding a constraint, such as “Use only the factual information provided above and do not invent additional details.”

The server uses a guidance adjustment function to modify the explanation information based on the emotional state of the user. The server may alter the order in which sightseeing targets appear, emphasize certain sentences by inserting leading phrases, or adjust the description length for each part. This adjustment is done at the server side using an algorithm that assesses whether each part of the explanation information is aligned with emotional categories. For example, for a user in a “wants to relax” state, the server places relaxing spots at the beginning and compresses descriptions of highly stimulating spots. This adjustment contributes to technical improvement because it allows more efficient use of limited display space on small devices such as smart glasses, and reduces cognitive load by ordering content by relevance.

The terminal receives the explanation information from the server and renders it by means of its display apparatus and audio output apparatus. The terminal formats the explanation information into UI elements, such as titles, paragraphs, and bullet points, in accordance with metadata supplied by the server. For head-mounted displays or smart glasses, the terminal may overlay short text snippets or icons near an approximate direction of the sightseeing targets, using orientation sensors to align the display. The terminal also converts the explanation information into audio via a text-to-speech engine, so that the user can receive guidance without having to look at the display.

The user experiences the guidance, perceives the displayed or spoken content, and may issue further requests via speech or touch input. The terminal performs automatic speech recognition to convert spoken user queries into text, and sends the text to the server as new user input. The server interprets this input as a new or refined request and constructs a new prompt sentence based on the previous context, so that the generative AI model can generate follow-up explanation information. For example, if the user says, “Tell me more about the history of Zojo-ji Temple,” the server constructs a prompt sentence such as:
“The user asked: ‘Tell me more about the history of Zojo-ji Temple.’
Database record for Zojo-ji Temple: [structured historical background data].
Using only the database record, generate a concise but detailed historical explanation suitable for a tourist.”

By conditioning the generative AI model on structured data and by using a fixed prompt frame, the server prevents the model from drifting into unrelated topics and ensures that the generated explanation information remains aligned with database contents. This design leads to improved accuracy and reduced error rates, which are technical effects over naive use of a generative AI model.

In addition to the described embodiment, the server may adopt alternative architectures. The generative AI model may be deployed on a dedicated accelerator node communicating via a low-latency protocol, and the ranking and prompt generation functions may be executed on an edge server located closer to the mobile body. The emotion recognition function may be partially executed on the terminal to reduce bandwidth consumption by transmitting only feature-level data. In another variant, the server uses reinforcement learning to adjust the weighting parameters of the ranking function and the structure of prompt sentences by receiving user satisfaction feedback. In this case, the server updates its weighting parameters in an online fashion using a reward signal, thereby further optimizing the mapping from sensor inputs to explanation information.

Multiple implementation forms may coexist. In one form, the system primarily serves users inside autonomous vehicles and integrates tightly with the vehicle's control unit, so that the same processor performs both automatic traveling control and prompt generation. In another form, the system operates as a cloud-based guidance service that cooperates with different types of mobile bodies and terminals, but maintains the same internal data structures, neural network architectures, and prompt generation algorithms. In each case, the server, the terminal, and the mobile body implement an interdependent set of operations that go beyond abstract data processing and result in concrete technical effects, such as reduced network traffic by candidate selection, improved computational efficiency through structured prompt composition, and increased guidance accuracy by combining multimodal emotion recognition with database-constrained generative text.

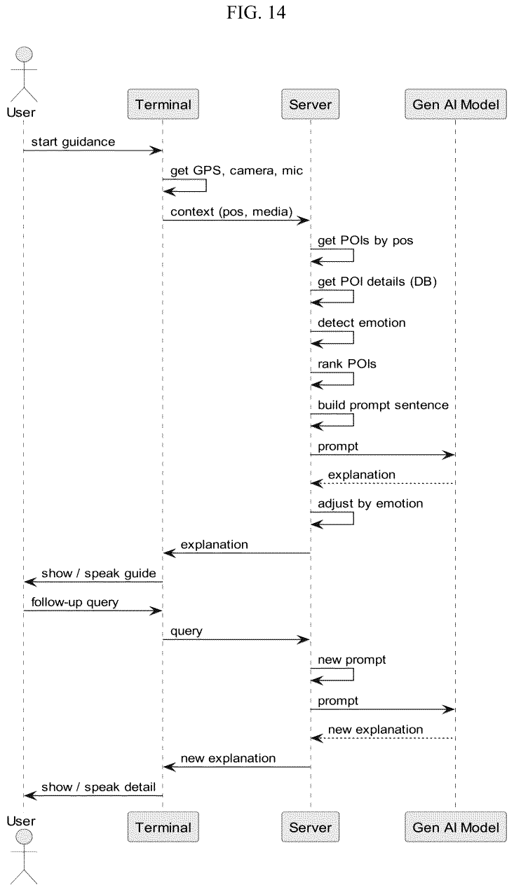

The following describes the processing flow using FIG. 14.

### Step 1:

The terminal acquires user context and transmits it to the server.

The terminal uses its positioning apparatus to measure satellite signals and compute current latitude, longitude, and a timestamp as input. The terminal also uses its camera and microphone to capture image information and audio information representing the user's face and voice as additional input. The terminal performs basic preprocessing, such as converting raw GPS readings into numerical coordinates and compressing image and audio streams into standard formats, as data processing. The terminal then outputs a context message including terminal ID, current position, timestamp, and either raw or preprocessed emotion-related data, and sends this message to the server over a network connection.

### Step 2:

The server acquires candidate sightseeing targets based on the position information.

The server receives the context message from the terminal as input. The server parses the message, extracts current position information, and validates coordinate ranges as initial data processing. The server then sends a request containing the coordinates to a map or place-information service, and receives a list of nearby points of interest as raw candidate data. The server filters these data by type and distance, and outputs a list of candidate sightseeing targets, each with at least an identifier, a name, a rough location, and a category, to be used in subsequent steps.

### Step 3:

The server retrieves structured sightseeing data from a database.

The server takes the list of candidate sightseeing targets as input. The server uses each identifier or name to generate database queries to a local or remote database that stores structured data fields, such as historical background, cultural background, recommended visiting time zone, recommended visiting season, and cautions. The server executes these queries, merges the retrieved records with the candidate list, and performs data normalization such as converting time formats and language codes. The server outputs a structured list of sightseeing targets, where each target contains complete structured fields for later ranking and prompt construction.

### Step 4:

The server determines the emotional state of the user.

The server takes the image information and audio information from the terminal as input. The server normalizes the image information by resizing and normalizing pixel values and extracts facial features using a convolutional feature extractor, and it normalizes audio information by computing time-frequency features such as spectral coefficients as data processing. The server feeds these feature vectors into one or more trained classifiers, such as a convolutional neural network for images and a sequence model for audio, and then fuses their outputs by computing weighted averages of probability distributions. The server outputs an emotional state label (for example, excited, relaxed, bored, or sad) with an associated confidence score, and stores this label as part of the user context.

### Step 5:

The server computes ranking scores for the sightseeing targets.

The server uses the structured list of sightseeing targets and the emotional state label as input. The server first calculates distances from the user's current position to each sightseeing target using a geodesic distance formula and, when available, estimated travel time from routing data. The server then evaluates tag compatibility between each sightseeing target's attributes (for example, exciting, relaxing, quiet, lively) and the emotional state by applying a scoring rule table. The server combines distance, travel time, target rating, and emotional compatibility into a composite score using a weighted sum or similar function. The server outputs an ordered list of sightseeing targets ranked by score, and selects a subset of top-ranked targets for explanation.

### Step 6:

The server constructs a prompt sentence for the generative AI model.

The server takes the top-ranked sightseeing targets, the current position information, and the emotional state as input. The server applies a deterministic template to organize these data into labeled text sections, for example “Current location,” “User emotion,” and “Nearby spots.” The server performs string concatenation and formatting operations to convert structured fields into readable descriptions, and inserts them into the template. The server also appends an explicit instruction section that defines the role of the generative AI model and the required output style and length. The server outputs a prompt sentence such as:
“Current location: near Tokyo Tower in Tokyo, Japan.
User emotion: excited.
Nearby spots:
1) Tokyo Tower—landmark, built in 1958, great night view; tags: exciting, panorama.
2) Zojo-ji Temple—historical temple, quiet atmosphere, important in the Edo period; tags: cultural, relaxing.

You are a travel guide. Using this information, generate a friendly explanation of these spots, focusing on what an excited tourist would enjoy. Recommend an order to visit and include brief reasons.”

### Step 7:

The server invokes the generative AI model and generates explanation information.

The server uses the prompt sentence as input. The server tokenizes the text into subword units and feeds the resulting token sequence into a generative AI model, such as a transformer-based sequence-to-sequence model, by sending it through a model interface. The generative AI model performs internal matrix multiplications, attention-weight calculations, and non-linear activations to compute contextual token embeddings, and then predicts output tokens one by one according to the model parameters and generation settings. The server collects the generated token sequence, decodes it back into natural-language text, and optionally post-processes the text by splitting it into paragraphs, removing incomplete sentences, and ensuring that each selected sightseeing target is mentioned. The server outputs explanation information as a coherent text document describing the selected sightseeing targets.

### Step 8:

The server adjusts the generated explanation information based on the emotional state.

The server uses the explanation information and the emotional state label as input. The server analyzes the text, for example by scanning for mentions of each sightseeing target and by identifying sentences indicating excitement, relaxation, or warnings. The server applies a rule-based algorithm or a simple classifier to assign tags to sentences, and then reorders, expands, or compresses portions of the text in accordance with the emotional state. For instance, when the emotional state is “wants to relax,” the server moves relaxing spots to the beginning, increases the detail level of relaxing descriptions, and shortens descriptions of highly stimulating attractions. The server outputs adjusted explanation information with an updated structure that better matches the user's emotional state and display constraints.

### Step 9:

The server transmits the explanation information to the terminal.

The server takes the adjusted explanation information, along with optional metadata such as target identifiers and recommended order, as input. The server packages these data into a response message suitable for the client protocol, and applies data compression or chunking if the message is large. The server then sends the response message to the terminal over the network. The server outputs a fully formatted payload ready for presentation, and may log the transaction for later analysis and model improvement.

### Step 10:

The terminal presents the explanation information to the user.

The terminal receives the response message from the server as input. The terminal parses the message, extracts the explanation text and associated metadata, and maps them to visual and audio components of its user interface. The terminal performs layout calculations to render titles, paragraphs, and lists on the display apparatus, and may align specific items with directions or icons when using a head-mounted display. The terminal also passes the explanation text to a text-to-speech engine, which converts the text into an audio waveform. The terminal outputs visual images on the display and audio signals through the audio output apparatus, thereby presenting the explanation information to the user.

### Step 11:

The user consumes the information and issues additional requests.

The user takes the visual and audio guidance from the terminal as input in a human-perception sense. The user evaluates whether the information is sufficient, and may decide to request more detail or a different type of guidance. The user speaks or enters a new query, such as “Tell me more about the history of Zojo-ji Temple,” as output behavior. This new user input becomes the next input for the terminal, which then processes and forwards it to the server.

### Step 12:

The terminal forwards user follow-up queries to the server.

The terminal takes the user's spoken or typed query as input. The terminal applies speech recognition to convert audio into text when necessary, and associates the query with the ongoing session and current context identifiers. The terminal may perform preliminary intent detection to identify references to specific sightseeing targets, and then packages the query as a follow-up request message including the query text and context IDs. The terminal outputs this request to the server, which uses it to construct a new prompt sentence that conditions the generative AI model on both the original structured data and the user's new request.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

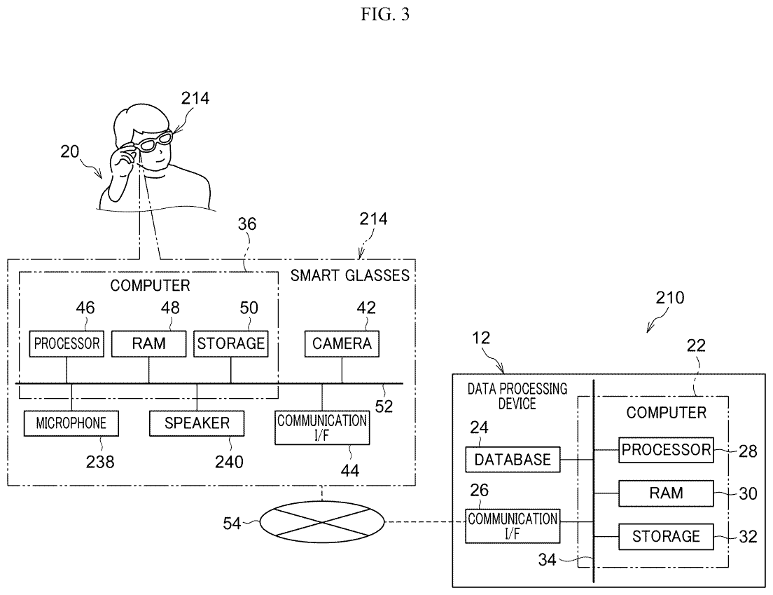

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

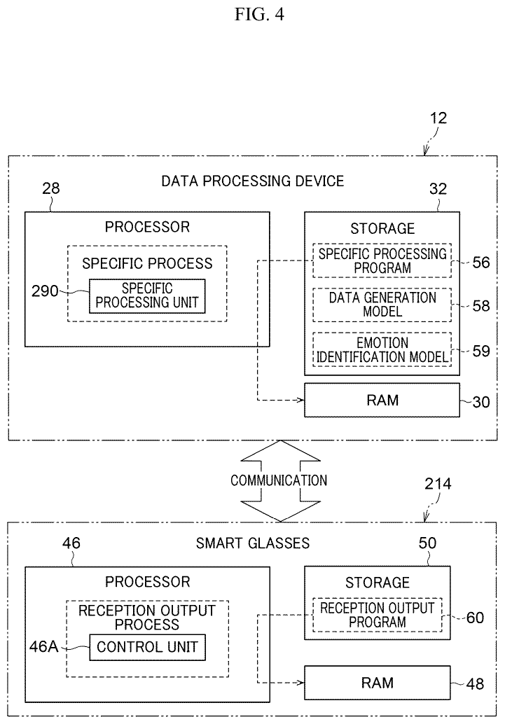

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

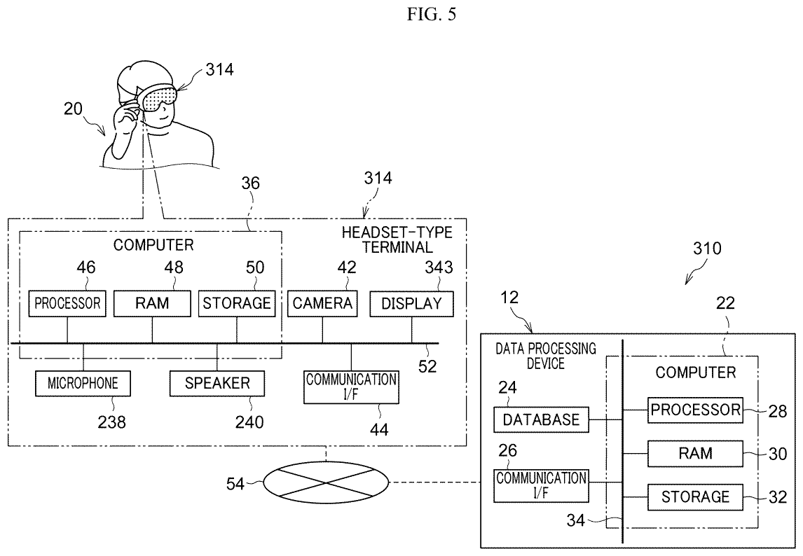

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

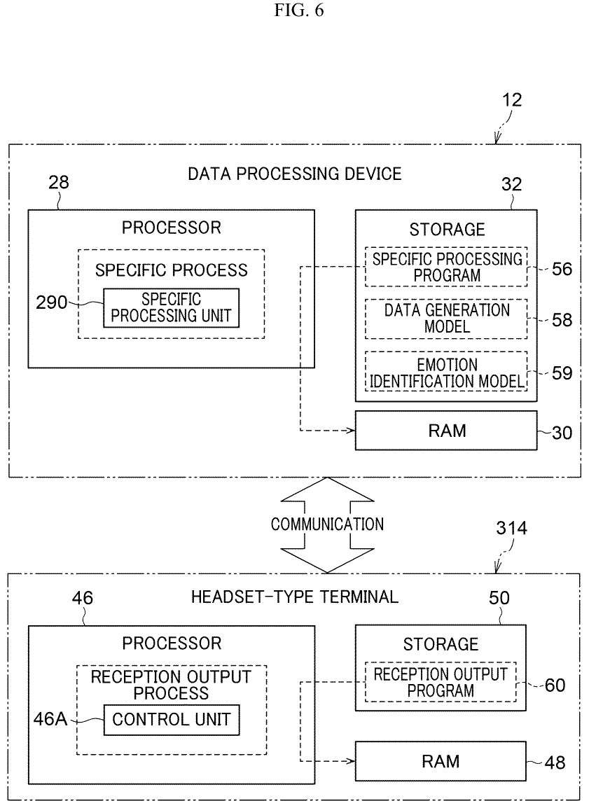

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

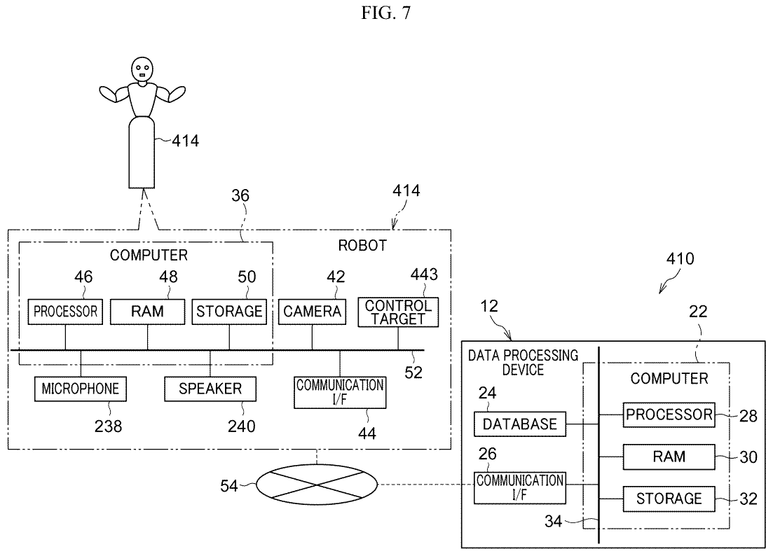

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

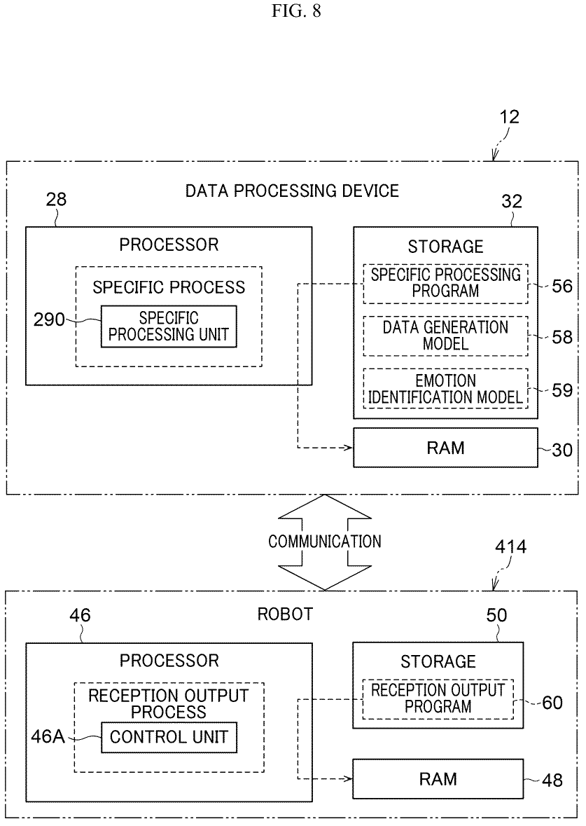

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

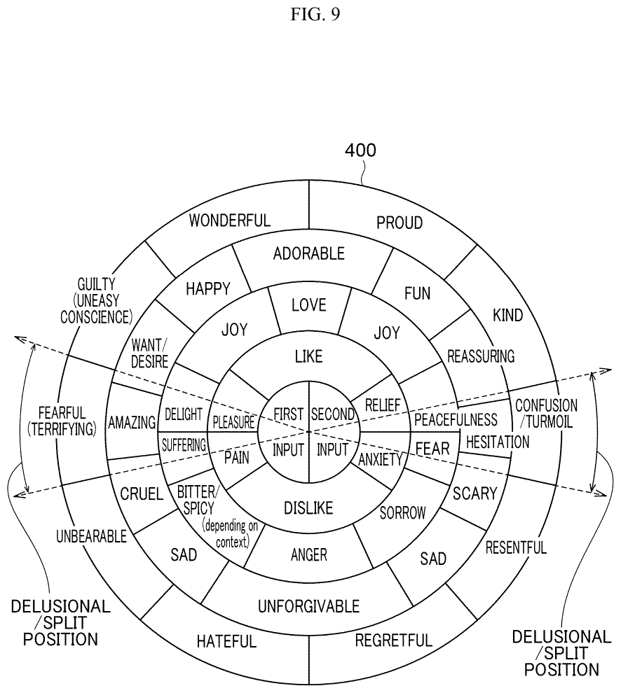

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

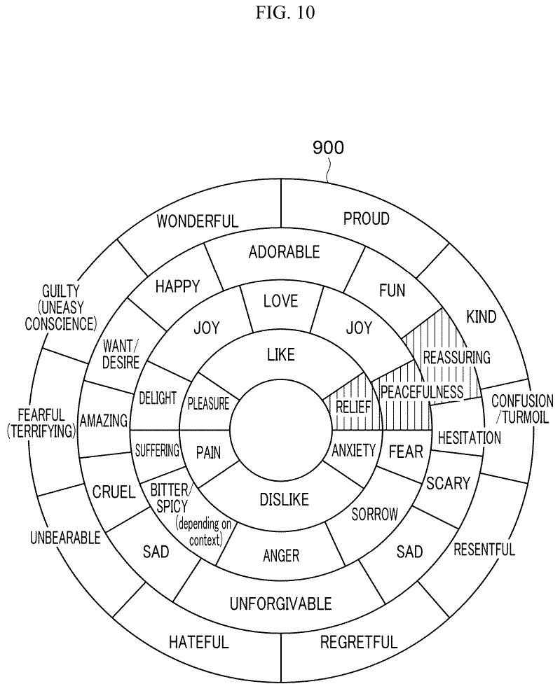

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire position information of a mobile body by using a positioning device,
specify a surrounding area based on the position information and extract sightseeing-related information, as sightseeing object information, from an information storage device in which sightseeing-related information is recorded in association with areas, generate structured information including at least a name, a type, and an outline of each sightseeing object on the basis of the sightseeing object information and the position information, and generate a prompt sentence including the structured information and user attribute information,
input the prompt sentence to a generative AI model, instruct the generative AI model to generate a sightseeing guidance natural language description, and obtain the sightseeing guidance natural language description from the generative AI model,
format guidance information data including the sightseeing guidance natural language description and the sightseeing object information into a predetermined data format and transmit the guidance information data to a user terminal, and
record a generation history and a transmission history of the guidance information data and sequentially update the prompt sentence and the sightseeing guidance natural language description in response to updating of the position information.

### (Supplementary 2)

The system according to supplementary 1,
wherein the processor is configured to
include, in the guidance information data, coordinate information of each sightseeing object and distance information calculated on the basis of the position information, include, in the prompt sentence, priority information and display style instruction information based on the distance information, and instruct the generative AI model to generate the sightseeing guidance natural language description reflecting the priority information and the display style instruction information.

### (Supplementary 3)

The system according to supplementary 1,
wherein the processor is configured to
include, in the prompt sentence, region name information specified based on the position information, category information of the sightseeing object information, preference information of a user, and condition information regarding an output language and a writing style of the guidance information data, and instruct the generative AI model to generate the sightseeing guidance natural language description reflecting the region name information, the category information, the preference information, and the condition information.

### Application Example 1

### (Supplementary 1)

A system comprising a processor,
wherein the processor is configured to
control a moving body to provide an autonomous travel function,
communicate with a shared-use service for the moving body to exchange reservation information and usage status information and to manage the reservation information and the usage status information,
acquire position information from a positioning device and specify a current position of the moving body based on the position information,
search an information storage device, based on the current position, for candidates of stay targets existing in a vicinity of the current position and generate candidate list information including the candidates of the stay targets,
transmit the candidate list information to a communication terminal and output information including identification information for each of the stay targets, the information being used by the communication terminal to perform display control and to receive, from a user, a selection operation on the candidates of the stay targets,
receive, from the communication terminal, the identification information corresponding to the selection operation, and acquire attribute information and position information of a stay target associated with the identification information from the information storage device,
generate document data including preference information and state information regarding the user, the current position, the attribute information and the position information of the stay target, travel route information, and required time information, and configure the document data as a prompt sentence to be input to a generative information processing model,
input the prompt sentence to the generative information processing model and obtain, from the generative information processing model, a generation result including personalized guidance information and itinerary proposal information relating to the stay target,
integrate the generation result with basic information stored in the information storage device to generate detailed guidance information, and transmit the detailed guidance information to the communication terminal to cause the communication terminal to present the detailed guidance information,
regenerate, based on position information that is updated while the moving body is traveling, at least one of the candidate list information and the detailed guidance information in accordance with a predetermined condition, dynamically update contents of the prompt sentence, and use the updated prompt sentence as an input to the generative information processing model, and
accept input operations from the user and inquiry content regarding the detailed guidance information, generate a dialogue prompt sentence by combining the inquiry content with context information relating to the current position, the stay target, and past generation results, re-input the dialogue prompt sentence to the generative information processing model to obtain response information, and transmit the response information to the communication terminal.

### (Supplementary 2)

The system according to supplementary 1,
wherein the processor is configured to
acquire state information from a detection device that detects an operation state of the moving body, determine control conditions indicating at least one of timing, level of detail, and
expression format of information presentation to the user based on the state information, and
reflect the control conditions in the prompt sentence and the detailed guidance information so as to dynamically change contents and presentation modes of sightseeing guidance in accordance with an operation situation of the moving body.

### (Supplementary 3)

The system according to supplementary 1,
wherein the processor is configured to
acquire additional information from the information storage device, the additional information including at least one of history information, background information,
recommended visiting time zones, recommended visiting periods, caution information relating to the stay target, and combination candidates with other stay targets and eating and drinking facilities in a surrounding area, include the additional information, together with the preference information regarding the user and information regarding the current position, in the prompt sentence, and cause the generative information processing model to generate,
based on the prompt sentence, detailed guidance information and an action plan in which the additional information is reflected.

### Example 2

### (Supplementary 1)

A system comprising a processor,
wherein the processor is configured to
acquire position information of a mobile body,
acquire traffic condition information around the mobile body from an external information processing apparatus,
generate a prompt sentence including generation conditions for sightseeing guidance content based on the acquired position information and the acquired traffic condition information,
cause a generative AI model to generate sightseeing guidance information in a natural language by inputting the prompt sentence to the generative AI model,
transmit the generated sightseeing guidance information to an information terminal and cause the information terminal to present the sightseeing guidance information visually or audibly, and
update a next prompt sentence to be generated based on a presentation history of the sightseeing guidance information and a travel history of the mobile body so as to suppress generation of duplicate sightseeing guidance information.

### (Supplementary 2)

The system according to supplementary 1,
wherein the processor is configured to
determine at least one of a congestion state, a running state, and a stop state based on the acquired traffic condition information, and
generate the prompt sentence including a description that designates at least one sightseeing guidance format among a short-stay format, a long-stay format, and an in-vehicle-viewing format according to a result of the determination.

### (Supplementary 3)

The system according to supplementary 1,
wherein the processor is configured to
provide, to the information terminal, user interface information for accepting additional input representing a request for supplemental explanation or detailed information to be given to the generative AI model,
receive the additional input from the information terminal,
reconstruct the prompt sentence according to the additional input, and cause the generative AI model to generate follow-up sightseeing guidance information by re-inputting the reconstructed prompt sentence to the generative AI model.

### Application Example 2

### (Supplementary 1)

A system comprising a processor,
wherein the processor is configured to
control a mobile body for transportation so as to perform automatic traveling control, and
manage, in cooperation with a shared-use management service, reservation information and usage status regarding the mobile body, and
acquire current position information from a positioning apparatus and, based on the acquired current position information, acquire candidate information of surrounding sightseeing targets as location-related information, and
select the sightseeing targets by ranking the candidate information based on the acquired candidate information and an emotional state of a user by use of a candidate selection function, and
generate a text including at least the selected candidate information and the emotional state of the user, and construct a prompt sentence for input to a generative information processing model by using the generated text by use of a prompt generation function, and
cause the generative information processing model to generate, in a natural language, explanation information relating to the sightseeing targets by inputting the prompt sentence to the generative information processing model by use of a generation instruction function, and identify the emotional state of the user based on at least one of image information and audio information by use of an emotion recognition function, and
adjust content or a presentation order of the explanation information generated by the generative information processing model, in accordance with the emotional state identified by the emotion recognition function, by use of a guidance adjustment function, and
present the explanation information to the user through at least one of a display apparatus and an audio output apparatus by use of an information presentation function.

### (Supplementary 2)

The system according to supplementary 1,
wherein the processor is configured to
acquire traveling state information of the mobile body from a state detection apparatus configured to detect a traveling state of the mobile body and traffic situation information,
determine whether a congestion state exists based on the traveling state information and the traffic situation information, and, when the congestion state is determined to exist, generate a prompt sentence that instructs the generative information processing model to generate explanation information of sightseeing targets assumed to be viewed or listened to by the user during a waiting time, and cause the generative information processing model to generate the explanation information for the congestion state by inputting the prompt sentence.

### (Supplementary 3)

The system according to supplementary 1,
wherein the processor is configured to
acquire structured data including, for each sightseeing target, historical background information, cultural background information, recommended visiting time zone information, recommended visiting season information, and caution information, generate a prompt sentence including the structured data by use of the prompt generation function, and cause the generative information processing model to generate, in the natural language, detailed explanation information in which the historical background information, the cultural background information, the recommended visiting time zone information, the recommended visiting season information, and the caution information are integrated based on the structured data by inputting the prompt sentence.

What is claimed is:

1. A system comprising:
circuitry configured to:
acquire, via a communication interface coupled to a packet-switched network, position data from a positioning device associated with a mobile apparatus;
execute a spatial query against a storage device to extract, based on the position data, location-associated records within a computed surrounding region, and generate structured information comprising at least a name field, a type field, and an outline field for each extracted record together with distance information derived from the position data;
construct a prompt data structure by combining the structured information, user attribute data retrieved from the storage device, and priority information computed from the distance information, and provide the prompt data structure as input to a generative neural network model;
obtain, from the generative neural network model, a natural language description responsive to the prompt data structure;
format guidance data comprising the natural language description and the structured information into a transmission payload, and transmit the transmission payload to a terminal device via the communication interface; and
record, in the storage device, a generation history and a transmission history associated with the guidance data, and selectively update the prompt data structure and the natural language description in response to updated position data by referencing the generation history to suppress redundant invocation of the generative neural network model.

2. The system according to claim 1,
wherein the circuitry is further configured to include, in the prompt data structure, display style instruction information specifying at least one of grouping, emphasis level, or summarization granularity for the natural language description, the display style instruction information being derived from the distance information and the user attribute data.

3. The system according to claim 2,
wherein the circuitry is further configured to include, in the prompt data structure, region name information determined from the position data, category information associated with each extracted record, and condition information specifying an output language and a writing style for the natural language description.

4. The system according to claim 3,
wherein the circuitry is further configured to receive, from the terminal device, a refinement request comprising a selected record identifier and updated preference information, construct a refined prompt data structure incorporating the refinement request and context from a previously generated natural language description, and provide the refined prompt data structure to the generative neural network model to obtain a follow-up natural language description.

5. The system according to claim 4,
wherein the refinement request comprises a user-entered natural language query, and the circuitry constructs a dialogue prompt data structure by combining the natural language query with the selected record identifier, attribute information of the selected record, and a summary of past generation results stored in the generation history.

6. The system according to claim 5,
wherein the circuitry is further configured to transmit response information generated from the dialogue prompt data structure to the terminal device, and update a session context stored in the storage device to associate the response information with the selected record identifier and the position data, the session context being referenced in subsequent dialogue prompt data structure construction to avoid recomputation of prior context.

7. The system according to claim 1,
wherein the circuitry is further configured to:
control the mobile apparatus to perform an autonomous travel function;
communicate, via the communication interface, with a shared-use management service to exchange reservation data and usage status data associated with the mobile apparatus; and
transmit candidate list information comprising a plurality of extracted records to the terminal device to cause the terminal device to present selectable identification information for each record.

8. The system according to claim 7,
wherein the circuitry is further configured to acquire operation state data from a detection device that detects a traveling state of the mobile apparatus, determine control conditions indicating at least one of timing of information presentation, level of detail, and expression format based on the operation state data, and reflect the control conditions in the prompt data structure and the guidance data.

9. The system according to claim 8,
wherein the control conditions specify a short-duration format when the operation state data indicates a running state, a long-duration format when the operation state data indicates a stop state, and a passive-viewing format when the operation state data indicates a congestion state, each format corresponding to a different maximum output length parameter and summarization level applied to the generative neural network model.

10. The system according to claim 9,
wherein the circuitry is further configured to schedule invocation of the generative neural network model based on the operation state data, deferring generation of detailed guidance data to intervals during which the mobile apparatus is in the stop state or the congestion state, and transmitting only abbreviated notification data during the running state.

11. The system according to claim 1,
wherein the circuitry is further configured to acquire traffic condition data from an external information processing apparatus via the communication interface, determine at least one of a congestion state, a running state, and a stop state based on the traffic condition data, and incorporate a state-dependent generation condition into the prompt data structure that adjusts content scope and verbosity of the natural language description in accordance with the determined state.

12. The system according to claim 11,
wherein the circuitry is further configured to maintain a presentation history recording identifiers of previously transmitted guidance data and associated position data, compare newly extracted location-associated records against the presentation history, and suppress generation of the natural language description for records that were previously transmitted within a predetermined distance threshold or time window.

13. The system according to claim 12,
wherein the circuitry is further configured to, when the presentation history indicates prior transmission for a given record, construct an incremental prompt data structure requesting alternative content perspectives or updated contextual information for the given record, thereby avoiding duplicate content while providing new information.

14. The system according to claim 1,
wherein the circuitry is further configured to identify an emotional state of a user based on at least one of image data captured by an imaging device and audio data captured by a sound collection device, and adjust at least one of content or presentation order of the natural language description in accordance with the identified emotional state.

15. The system according to claim 14,
wherein the circuitry identifies the emotional state by processing the image data through a convolutional feature extractor to obtain a visual emotion probability vector, processing the audio data through a sequence model to obtain an audio emotion probability vector, and computing a fused emotional state label by weighted combination of the visual and audio emotion probability vectors.

16. The system according to claim 15,
wherein the circuitry is further configured to compute a ranking score for each extracted record by combining the distance information, a popularity metric stored in the storage device, and a compatibility weight derived from the fused emotional state label and attribute tags associated with each record, and select a subset of top-ranked records for inclusion in the prompt data structure.

17. The system according to claim 16,
wherein the attribute tags comprise at least one of historical background information, cultural background information, recommended visiting time period information, recommended visiting season information, and caution information for each location-associated record, and the prompt data structure incorporates the attribute tags as structured fields to constrain the generative neural network model to generate the natural language description reflecting the attribute tags.

18. A system comprising:
circuitry configured to:
acquire position data from a positioning device via a communication interface coupled to a packet-switched network, and execute a spatial query against a storage device to identify location-associated records within a computed region based on the position data;
generate structured information for each identified record comprising a name, a type, an outline, coordinate data, and distance data computed from the position data;
retrieve user attribute data and combine the user attribute data with the structured information, priority data derived from the distance data, and display style instruction data to construct a prompt data structure;
provide the prompt data structure to a generative neural network model and obtain a natural language description;
format the natural language description and the structured information into guidance data, transmit the guidance data to a terminal device, and record a generation history and a transmission history in the storage device;
determine, based on a comparison of updated position data against the generation history, whether a regeneration condition is satisfied, and upon satisfaction, selectively regenerate the prompt data structure and the natural language description while reusing cached guidance data for unchanged records; and
acquire operation state data from a detection device, determine control conditions specifying timing and verbosity of information presentation based on the operation state data, and apply the control conditions to at least one of the prompt data structure and the guidance data.

19. The system according to claim 18,
wherein the circuitry is further configured to identify an emotional state of a user from at least one of image data and audio data, incorporate the emotional state into the prompt data structure as a generation condition, and reorder content segments of the natural language description based on the emotional state prior to transmission.

20. A method comprising:
acquiring, by circuitry via a communication interface coupled to a packet-switched network, position data from a positioning device associated with a mobile apparatus;
executing, by the circuitry, a spatial query against a storage device to extract location-associated records within a computed surrounding region based on the position data, and generating structured information comprising at least a name field, a type field, and an outline field for each extracted record together with distance information;
constructing, by the circuitry, a prompt data structure by combining the structured information, user attribute data, and priority information computed from the distance information, and providing the prompt data structure as input to a generative neural network model;
obtaining, from the generative neural network model, a natural language description responsive to the prompt data structure;
formatting guidance data comprising the natural language description and the structured information into a transmission payload and transmitting the transmission payload to a terminal device; and
recording a generation history and a transmission history associated with the guidance data, and selectively updating the prompt data structure and the natural language description in response to updated position data by referencing the generation history to suppress redundant invocation of the generative neural network model.
